(19) United States
(12) Patent Application Publication
(10) Pub. No.: US 2024/0127074 A1
(43) Pub. Date: Apr. 18, 2024

(54) MULTI-TASK NETWORK MODEL–BASED COMMUNICATION METHOD, APPARATUS, AND SYSTEM

(71) Applicant: HUAWEI TECHNOLOGIES CO., LTD., Shenzhen (CN)

(72) Inventors: Mengyang WANG, Shenzhen (CN); Jiahui LI, Shenzhen (CN); Mengyao MA, Shenzhen (CN); Junwen XIE, Shenzhen (CN); Zhicong ZHANG, Shenzhen (CN); Min YAN, Shenzhen (CN)

(21) Appl. No.: 18/398,520

(22) Filed: Dec. 28, 2023

Related U.S. Application Data
(63) Continuation of application No. PCT/CN2022/100097, filed on Jun. 21, 2022.

(30) Foreign Application Priority Data
Jun. 29, 2021 (CN) 202110748182.0

(51) Int. Cl. G06N 3/096

(52) U.S. Cl. CPC G06N 3/096

(57) ABSTRACT

The technology of this application relates to a multi-task network model-based communication method, apparatus, and system. The method may include a first communication apparatus processing an input signal by using a first backbone network model, to obtain a fusion feature, where the fusion feature is obtained by fusing a plurality of first features which are obtained by performing feature extraction on the input signal. The method may further include performing compression and channel coding on the fusion feature to obtain first information, and sending the first information to a second communication apparatus. The second communication apparatus receives second information from the first communication apparatus, performs decompression and channel decoding on the second information to obtain a reconstructed feature of the fusion feature, performs feature parsing on the reconstructed feature by using a second backbone network model, to obtain a feature parsing result, and processes the feature parsing result by using a functional network model.

### CROSS-REFERENCE TO RELATED APPLICATIONS

This application is a continuation of International Application No. PCT/CN2022/100097, filed on Jun. 21, 2022, which claims priority to Chinese Patent Application No. 202110748182.0, filed on Jun. 29, 2021. The disclosures of the aforementioned applications are hereby incorporated by reference in their entireties.

### TECHNICAL FIELD

Embodiments of this application relate to the field of communication technologies, and in particular, to a multi-task network model-based communication method, apparatus, and system.

### BACKGROUND

With development of deep learning, a convolutional neural network (CNN) plays an increasingly important role in the computer vision field. For example, tasks such as detection, tracking, recognition, classification, or prediction can be resolved by using a corresponding network model established by using the CNN. Generally, each network model can resolve only one task. This mode in which the network model one-to-one corresponds to the task is referred to as a single task learning (STL) mode. Based on the STL mode, a plurality of network models are required for resolving a plurality of tasks, which is inefficient and consumes storage space. Based on this, a multi-task learning (MTL) model is proposed, and the MTL model uses a multi-task network model. In the multi-task network model, a plurality of functional network models share an intermediate feature generated by a backbone network model, and different functional network models respectively complete different tasks. The MTL model can be more efficient and reduce storage costs of the model.

In recent years, although performance of the CNN model is increasingly high, a structure of the model is increasingly complex and increasingly more computing resources are required, and a common mobile device cannot provide sufficient computing resources for the model. Therefore, a model running mode of device-cloud collaboration is proposed, that is, collaborative intelligence (CI). A model in the CI scenario is divided into two parts: one part is located on a mobile device, and the other part is located on a cloud. The mobile device runs the one part of the network model, and the cloud runs the other part of the network model. An intermediate feature needs to be transmitted between the mobile device and the cloud to achieve collaboration. The model running mode of device-cloud collaboration can reduce computing costs of the mobile device.

A structure of the multi-task network model in the MTL mode is complex. How to implement device-cloud collaboration in the MTL mode is a problem to be resolved.

### SUMMARY

Embodiments of this application provide a multi-task network model-based communication method, apparatus, and system, to implement device-cloud collaboration in an MTL mode.

According to a first aspect, a multi-task network model-based communication method is provided. The method may be performed by a first communication apparatus, or may be performed by a component (for example, a processor, a chip, or a chip system) of the first communication apparatus. The first communication apparatus may be a terminal device or a cloud, and the multi-task network model includes a first backbone network model. The method may be implemented by using the following steps: The first communication apparatus processes an input signal by using the first backbone network model, to obtain a fusion feature, where the fusion feature is obtained by fusing a plurality of first features, and the plurality of first features are obtained by performing feature extraction on the input signal. The first communication apparatus performs compression and channel coding on the fusion feature to obtain first information. The first communication apparatus sends the first information to a second communication apparatus. The plurality of first features extracted from the input signal are fused, so that the obtained fusion feature can include more information. Therefore, the second communication apparatus can perform more accurate processing on the other part of the network model based on the fusion feature. The fusion feature is generated in a feature extraction phase, so that a structure of the multi-task network model can be clearer. This facilitates the multi-task network model being divided into a part executed by the first communication apparatus and the other part executed by the second communication apparatus, and further facilitates implementing device-cloud collaboration in an MTL mode. In addition, through compression, there are only a few parameters transmitted between the first communication apparatus and the second communication apparatus, so that transmission overheads are reduced. Through channel coding, anti-noise performance of data transmitted between the first communication apparatus and the second communication apparatus can be better achieved.

In a possible implementation, when the first communication apparatus processes the input signal by using the first backbone network model, to obtain the fusion feature, the first communication apparatus specifically performs the following steps: The first communication apparatus performs feature extraction on the input signal to obtain a plurality of second features, where the plurality of second features have different feature dimensions; the first communication apparatus processes the feature dimensions of the plurality of second features to obtain the plurality of first features having a same feature dimension; and the first communication apparatus performs feature fusion on the plurality of first features to obtain the fusion feature. The plurality of first features that are of different dimensions and that include different information are fused into one group of features, so that the fusion feature has abundant information. That information from different sources is fused to each other also achieves information complementarity to some extent.

In a possible implementation, when the first communication apparatus processes the feature dimensions of the plurality of first features to obtain the plurality of first features having the same feature dimension, the first communication apparatus may specifically perform a first convolution operation and an upsampling operation on the plurality of first features, to obtain the plurality of first features having the same feature dimension. The upsampling operation may be performed to separately change a height and a width of the first feature to any value, which is not limited to an integer multiple. For example, eight times or more of an original height may be expanded, and an expansion multiple is any multiple. In a conventional operation, if a deconvolution operation is performed to change a height and a width of a feature, an expansion multiple can only be twice, and the expansion multiple needs to be an integer. Compared with the conventional operation, the upsampling operation expands the multiple of the dimension more flexibly.

In a possible implementation, that the first communication apparatus performs feature fusion on the plurality of first features to obtain the fusion feature may be specifically: The first communication apparatus adds the plurality of first features to obtain a third feature. Performing addition on the plurality of first features may be performing addition on elements at a same location in the plurality of first features, and a fused third feature can be obtained after the plurality of first features are added. A method for obtaining the third feature through addition is simple and effective, and can help reduce model complexity.

In a possible implementation, the first communication apparatus performs a second convolution operation on the third feature to obtain the fusion feature. The second convolution operation may use a 3*3 convolution operation, and input and output channel numbers of the second convolution operation may be controlled to be equal, that is, dimensions of the third feature and the fusion feature are the same. The second convolution operation is performed on the third feature, so that the obtained fusion feature is smoother. In this way, the fusion feature is more applicable to subsequent network model processing performed by the second communication apparatus, and a processing result is more accurate.

In a possible implementation, that the first communication apparatus performs compression and channel protection processing on the fusion feature may be that the first communication apparatus performs downsampling and a third convolution operation on the fusion feature by using a joint source-channel coding model, to obtain a fourth feature, where the joint source-channel coding model is trained based on channel noise. In this way, data processed by using the joint source-channel coding model can have better anti-noise performance. The second communication apparatus processes received data by using a joint source-channel decoding model corresponding to the joint source-channel coding model, and can obtain, through decoding, a reconstructed feature that is more similar to the fusion feature, so that performance of device-cloud collaboration is more stable and accurate. A height and a width of the fusion feature can be reduced through the downsampling. In a normal case, the convolution operation is performed to reduce the height and the width of the fusion feature. A multiple of the dimension reduced by the convolution operation is affected by a size of a convolution kernel, and can be reduced only to one of an integer multiple of an original dimension. In comparison, the downsampling can reduce the fusion feature to any dimension, and the dimension of the fusion feature can be reduced more flexibly through the downsampling. A feature channel number of the fusion feature can be reduced through the third convolution operation, so that the fusion feature can be transmitted more conveniently after being compressed.

In a possible implementation, that the first communication apparatus performs compression and channel protection processing on the fusion feature further includes:

The first communication apparatus performs one or more of the following operations on the fourth feature by using the joint source-channel coding model: generalized divisive normalization, a parametric rectified linear unit, or power normalization. The generalized divisive normalization may be used to improve a compression capability of the joint source-channel coding model, and the parametric rectified linear unit may also be used to improve the compression capability of the joint source-channel coding model. The power normalization may make a power of a compressed result be 1.

According to a second aspect, a multi-task network model-based communication method is provided. The method may be performed by a second communication apparatus, or may be performed by a component (for example, a processor, a chip, or a chip system) of the second communication apparatus. The second communication apparatus may be a cloud or may be a terminal device. The multi-task network model includes a second backbone network model and a functional network model. The method may be implemented by using the following steps: A second communication apparatus receives second information from a first communication apparatus; the second communication apparatus performs decompression and channel decoding on the second information, to obtain a reconstructed feature of a fusion feature, where the fusion feature is obtained by fusing a plurality of first features obtained by performing feature extraction on an input signal; the second communication apparatus performs feature parsing on the reconstructed feature by using the second backbone network model, to obtain a feature parsing result; and the second communication apparatus processes the feature parsing result by using the functional network model. The plurality of first features extracted from the input signal are fused, so that the obtained fusion feature can include more information. Therefore, the second communication apparatus can perform more accurate processing based on the reconstructed feature of the fusion feature. The fusion feature is generated in a feature extraction phase, so that a structure of the multi-task network model can be clearer. This facilitates the multi-task network model being divided, and further facilitates implementing device-cloud collaboration in an MTL mode. Through channel decoding, decoded second information can be closer to first information sent by the first communication apparatus, thereby improving anti-noise performance of data transmitted between the first communication apparatus and the second communication apparatus. In addition, the second communication apparatus can complete a plurality of tasks by receiving a group of features (that is, the fusion feature included in the first information), and does not need to input a plurality of groups of features to perform a plurality of tasks. The operation of the second communication apparatus is simpler. This facilitates the multi-task network model being divided into two parts, and is more applicable to a device-cloud collaboration scenario.

In a possible implementation, the feature parsing result includes X features, a 1^{st} feature in the X features is the reconstructed feature, and an (Xᵢ₊₁)^{th} feature in the X features is obtained through an operation on an Xᵢ^{th} feature; first Y features in the X features are obtained through a first operation, and last (X-Y) features in the X features are obtained through a second operation; and X, Y, and i are positive integers, i is less than or equal to X, and Y is less than or equal to X; and a convolution operation in the first operation has a plurality of receptive fields (receptive fields), and a convolution operation in the second operation has one receptive field. The first operation fuses convolution results of different receptive fields together, and is a feature fusion means. In the feature fusion means, different information is extracted and fused from different angles, so that a result of the first operation includes more information than a result of the second operation. This helps improve performance of the functional network model.

In a possible implementation, the first operation includes the following operations: performing a 1×1 convolution operation on a to-be-processed feature in the first Y features; separately performing a plurality of 3×3 convolution operations on a result of the lxi convolution operation, where the plurality of 3×3 convolution operations have different receptive field sizes; performing channel number dimension concatenation on a result of the plurality of 3×3 convolution operations; performing the lxi convolution operation on a result obtained through the channel number dimension concatenation, to obtain a first convolution result; and performing element-by-element addition on the first convolution result and the to-be-processed feature.

In a possible implementation, a height of the Xᵢ₊₁^{th} feature is ½ of a height of the Xᵢ^{th} feature, a width of the Xᵢ₊₁^{th} feature is ½ of a width of the Xᵢ^{th} feature, and a channel number of the Xᵢ₊₁^{th} feature is the same as a channel number of the Xᵢ^{th} feature. In this way, features of different scales can be extracted based on the reconstructed feature, and more abundant information can be provided for a subsequent functional network model, so that both data and a feature that are input to the functional network model are enhanced, thereby improving accuracy of processing the functional network model.

In a possible implementation, that the second communication apparatus performs decompression and channel decoding on the second information includes: The second communication apparatus performs the following operations on the second information by using a joint source-channel decoding model: a fourth convolution operation, an upsampling operation, and a fifth convolution operation. A spatial dimension of the feature can be restored through the upsampling operation. Compared with one convolution operation, when two convolution operations of the fourth convolution operation and the fifth convolution operation are used, the compressed fusion feature can be slowly restored, and a feature restoration capability is improved. Therefore, the restored reconstructed feature has more parameters, and using the more parameters can improve parsing accuracy of the network model.

In a possible implementation, that the second communication apparatus performs decompression and channel decoding on the second information further includes one or more of the following operations: inverse generalized divisive normalization (IGDN), a parametric rectified linear unit (PReLU), batch normalization (BN), or a rectified linear unit (ReLU). The IGDN may be used to improve a decompression capability or a decoding capability of the joint source-channel decoding model. The PReLU may also be used to improve the decompression capability or the decoding capability of the joint source-channel decoding model. The BN and/or the ReLU may limit a range of a decoding result, and may further increase accuracy of the decoding result.

According to a third aspect, a communication apparatus is provided. The apparatus may be a first communication apparatus, or may be an apparatus (for example, a chip, a chip system, or a circuit) located in the first communication apparatus, or may be an apparatus that can be used in a match with the first communication apparatus. The first communication apparatus may be a terminal device or may be a network device. The apparatus has a function of implementing the method in any one of the first aspect or the possible implementations of the first aspect. The function may be implemented by hardware, or may be implemented by hardware executing corresponding software. The hardware or software includes one or more modules corresponding to the foregoing functions. In an implementation, the apparatus may include a transceiver module and a processing module. For example,
the processing module is configured to process an input signal by using a first backbone network model, to obtain a fusion feature, where the fusion feature is obtained by fusing a plurality of first features, and the plurality of first features are obtained by performing feature extraction on the input signal; the processing module is further configured to perform compression and channel coding on the fusion feature to obtain first information; and the transceiver module is configured to send the first information to a second communication apparatus.

In a possible implementation, when processing the input signal by using the first backbone network model to obtain the fusion feature, the processing module is configured to: perform feature extraction on the input signal to obtain a plurality of second features, where the plurality of second features have different feature dimensions; process the feature dimensions of the plurality of second features to obtain the plurality of first features having a same feature dimension; and perform feature fusion on the plurality of first features to obtain the fusion feature.

In a possible implementation, when processing the feature dimensions of the plurality of first features to obtain the plurality of first features having the same feature dimension, the processing module is configured to perform a first convolution operation and an upsampling operation on the plurality of first features, to obtain the plurality of first features having the same feature dimension.

In a possible implementation, when performing feature fusion on the plurality of first features to obtain the fusion feature, the processing module is configured to add the plurality of first features to obtain a third feature.

In a possible implementation, the processing module is further configured to perform a second convolution operation on the third feature to obtain the fusion feature.

In a possible implementation, when performing compression and channel protection processing on the fusion feature, the processing module is configured to perform downsampling and a third convolution operation on the fusion feature by using a joint source-channel coding model, to obtain a fourth feature, where the joint source-channel coding model is trained based on channel noise.

In a possible implementation, when performing compression and channel protection processing on the fusion feature, the processing module is further configured to perform one or more of the following operations on the fourth feature by using the joint source-channel coding model: generalized divisive normalization, a parametric rectified linear unit, or power normalization.

For beneficial effects of the third aspect and the possible implementations, refer to descriptions of corresponding parts in the first aspect.

According to a fourth aspect, a communication apparatus is provided. The apparatus may be a second communication apparatus, or may be an apparatus (for example, a chip, a chip system, or a circuit) located in the second communication apparatus, or may be an apparatus that can be used in a match with the second communication apparatus. The second communication apparatus may be a terminal device or may be a network device. The apparatus has a function of implementing the method in any one of the second aspect or the possible implementations of the second aspect. The function may be implemented by hardware, or may be implemented by executing corresponding software by hardware. The hardware or software includes one or more modules corresponding to the foregoing functions. In an implementation, the apparatus may include a transceiver module and a processing module. For example, the transceiver module is configured to receive second information from a first communication apparatus. The processing module is configured to: perform decompression and channel decoding on the second information, to obtain a reconstructed feature of a fusion feature, where the fusion feature is obtained by fusing a plurality of first features obtained by performing feature extraction on an input signal; perform feature parsing on the reconstructed feature by using a second backbone network model in a multi-task network model, to obtain a feature parsing result; and process the feature parsing result by using a functional network model in the multi-task network model.

In a possible implementation, the feature parsing result includes X features, a 1^{st} feature in the X features is the reconstructed feature, and an (Xᵢ₊₁)^{th} feature in the X features is obtained through an operation on an Xᵢ^{th} feature; first Y features in the X features are obtained through a first operation, and last (X-Y) features in the X features are obtained through a second operation; and X, Y, and i are positive integers, i is less than or equal to X, and Y is less than or equal to X; and a convolution operation in the first operation has a plurality of receptive fields, and a convolution operation in the second operation has one receptive field.

In a possible implementation, a height of the Xᵢ₊₁^{th} feature is ½ of a height of the Xᵢ^{th} feature, a width of the Xᵢ₊₁^{th} feature is ½ of a width of the Xᵢ^{th} feature, and a channel number the Xᵢ₊₁^{th} feature is the same as a channel number the Xᵢ^{th} feature.

In a possible implementation, when performing decompression and channel decoding on the second information, the processing module is configured to perform the following operations on the second information by using a joint source-channel decoding model: a fourth convolution operation, an upsampling operation, and a fifth convolution operation.

In a possible implementation, when performing decompression and channel decoding on the second information, the processing module is further configured to perform one or more of the following operations: inverse generalized divisive normalization, a parametric rectified linear unit, batch normalization, or a rectified linear unit.

For beneficial effects of the fourth aspect and the possible implementations, refer to descriptions of corresponding parts in the second aspect.

According to a fifth aspect, an embodiment of this application provides a communication apparatus. The apparatus includes a communication interface and a processor. The communication interface is configured for communication between the apparatus and another device, for example, data or signal receiving and sending. For example, the communication interface may be a transceiver, a circuit, a bus, a module, or another type of communication interface, and the another device may be another communication apparatus. The processor is configured to invoke a group of programs, instructions, or data, to perform the method described in the first aspect or the possible implementations of the first aspect; or perform the method described in the second aspect or the possible implementations of the second aspect. The apparatus may further include a memory, configured to store the programs, the instructions, or the data that are invoked by the processor. The memory is coupled to the processor. When executing the instructions or data stored in the memory, the processor may implement the method described in the first aspect or the possible implementations of the first aspect, or may implement the method described in the second aspect or the possible implementations of the second aspect.

For beneficial effects of the fifth aspect, refer to descriptions of corresponding parts in the first aspect.

According to a sixth aspect, an embodiment of this application provides a communication apparatus. The apparatus includes a communication interface and a processor. The communication interface is configured for communication between the apparatus and another device, for example, data or signal receiving and sending. For example, the communication interface may be a transceiver, a circuit, a bus, a module, or another type of communication interface, and the another device may be another communication apparatus. The processor is configured to invoke a group of programs, instructions, or data to perform the method described in the second aspect or the possible implementations of the second aspect. The apparatus may further include a memory, configured to store the programs, the instructions, or the data that are invoked by the processor. The memory is coupled to the processor. When executing the instructions or the data stored in the memory, the processor may implement the method described in the second aspect or the possible implementations of the second aspect.

For beneficial effects of the sixth aspect, refer to descriptions of corresponding parts in the second aspect.

According to a seventh aspect, an embodiment of this application further provides a computer-readable storage medium. The computer-readable storage medium stores computer-readable instructions, and when the computer-readable instructions are run on a computer, the method in the aspects or the possible implementations of the aspects is performed.

According to an eighth aspect, an embodiment of this application provides a chip system. The chip system includes a processor, and may further include a memory, configured to implement the method in the first aspect or the possible implementations of the first aspect. The chip system may include a chip, or may include a chip and another discrete component.

According to a ninth aspect, an embodiment of this application provides a chip system. The chip system includes a processor, and may further include a memory, configured to implement the method in the second aspect or the possible implementations of the second aspect. The chip system may include a chip, or may include a chip and another discrete component.

According to a tenth aspect, a computer program product including instructions is provided. When the computer program product runs on a computer, the method in the foregoing aspects or the possible implementations of the aspects is performed.

### BRIEF DESCRIPTION OF DRAWINGS

FIG. 1 is an example schematic diagram of an architecture of a system according to an embodiment of this application;

FIG. 2 is an example schematic diagram of an architecture of a communication system according to an embodiment of this application;

FIG. 3 is an example schematic diagram of a structure of a neural network model according to an embodiment of this application;

FIG. 4a is an example schematic diagram 1 of a multi-task network model according to an embodiment of this application;

FIG. 4b is an example schematic diagram 2 of a multi-task network model according to an embodiment of this application;

FIG. 4c is an example schematic diagram 3 of a multi-task network model according to an embodiment of this application;

FIG. 4d is an example schematic diagram of a computer vision task network model according to an embodiment of this application;

FIG. 5 is an example schematic flowchart of a multi-task network model-based communication method according to an embodiment of this application;

FIG. 6 is an example schematic diagram of a process of a multi-task network model-based communication method according to an embodiment of this application;

FIG. 7 is an example schematic diagram of a process of feature fusion according to an embodiment of this application;

FIG. 8A and FIG. 8B are example schematic diagrams of a process of joint source-channel coding and decoding according to an embodiment of this application;

FIG. 9a is an example schematic diagram of a first operation according to an embodiment of this application;

FIG. 9b is an example schematic diagram of a second operation according to an embodiment of this application;

FIG. 10 is an example schematic diagram of a process of feature parsing according to an embodiment of this application;

FIG. 11a is an example performance comparison diagram 1 of a network model according to an embodiment of this application;

FIG. 11b is an example performance comparison diagram 2 of a network model according to an embodiment of this application;

FIG. 12 is an example schematic diagram 1 of a structure of a communication apparatus according to an embodiment of this application;

FIG. 13 is an example schematic diagram 2 of a structure of a communication apparatus according to an embodiment of this application; and

FIG. 14 is an example schematic diagram 3 of a structure of a communication apparatus according to an embodiment of this application.

### DESCRIPTION OF EMBODIMENTS

This application provides a multi-task network model-based communication method and apparatus, to better implement device-cloud collaboration in an MTL mode. The method and the apparatus are based on a same technical idea. Because a problem-resolving principle of the method is similar to a problem-resolving principle of the apparatus, mutual reference may be made to implementation of the apparatus and the method.

In descriptions of embodiments of this application, the term “and/or” describes an association relationship between associated objects and indicates that at least three relationships may exist. For example, A and/or B may indicate the following three cases: Only A exists, both A and B exist, and only B exists. The character “/” generally indicates an “or” relationship between the associated objects. In the descriptions of this application, terms such as “first” and “second” are only for distinction and description, but cannot be understood as indicating or implying relative importance, or as indicating or implying an order.

The following describes in detail embodiments of this application with reference to accompanying drawings.

The multi-task network model-based communication method provided in embodiments of this application may be applied to a 5G communication system, for example, a 5G new radio (NR) system, and may be applied to various application scenarios of the 5G communication system, for example, enhanced mobile broadband (eMBB), ultra-reliable ultra-low latency communication (URLLC), and enhanced machine type communication (eMTC). The multi-task network model-based communication method provided in embodiments of this application may also be applied to various future evolved communication systems, for example, a sixth generation (6G) communication system, or a space-air-ground integrated communication system. The multi-task network model-based communication method provided in embodiments of this application may be further applied to communication between base stations, communication between terminal devices, communication of internet of vehicles, internet of things, industrial internet, satellite communication, and the like. For example, the method may be applied to a device-to-device (D2D), vehicle-to-everything (V2X), or machine-to-machine (M2M) communication system.

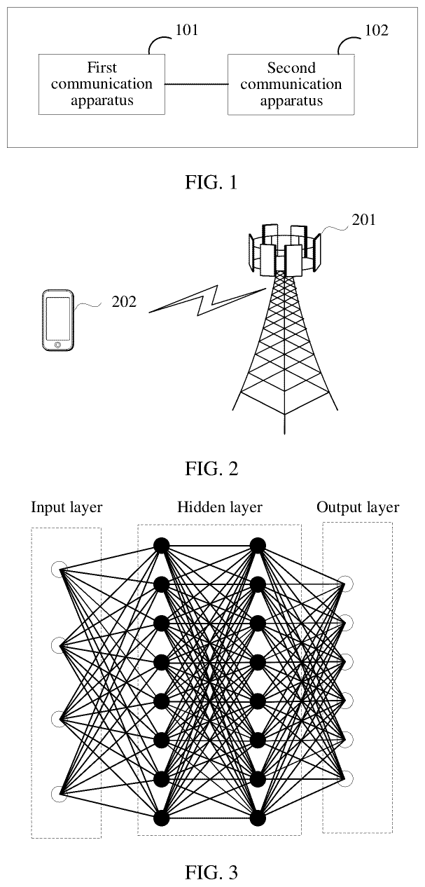

FIG. 1 shows an architecture of a system to which an embodiment of this application is applicable. The architecture of the system includes a first communication apparatus 101 and a second communication apparatus 102. The first communication apparatus 101 and the second communication apparatus 102 are two ends that cooperatively run a multi-task network model. A form of running the multi-task network model may be a network device, a terminal device, a cloud computing node, an edge server, a mobile edge computing (MEC) device, a computing power device, or the like. The first communication apparatus 101 and the second communication apparatus 102 may be connected in a wired or wireless manner. The first communication apparatus 101 and the second communication apparatus 102 may be any two ends that can run the multi-task network model. For example, the first communication apparatus 101 is a terminal device, and the second communication apparatus 102 may be a cloud computing node, a network device, an edge server, an MEC device, or a computing power device. For another example, the first communication apparatus 101 is a cloud computing node, a network device, an edge server, an MEC device, or a computing power device, and the second communication apparatus 102 may be a terminal device. The first communication apparatus 101 may be the foregoing device, or may be a component (for example, a processor, a chip, or a chip system) in the foregoing device, or may be an apparatus that matches the foregoing device. Similarly, the second communication apparatus 102 may be the foregoing device, or may be a component (for example, a processor, a chip, or a chip system) in the foregoing device, or may be an apparatus that matches the foregoing device.

Embodiments of this application are applicable to a scenario in which a multi-task network model is cooperatively run (which may be referred to as a cooperative running scenario below). Two ends that cooperatively run the multi-task network model may be any two ends. For example, when the multi-task network model is applied to a device-cloud collaboration scenario, the two ends may be respectively referred to as a terminal and a cloud. The terminal may be a terminal device or an apparatus (for example, a processor, a chip, or a chip system) in the terminal device. The cloud may be a network device, a cloud computing node, an edge server (edge server), an MEC device, or a computing power device. The cloud may also be in a form of software having a computing capability.

The following uses examples to describe possible implementation forms and functions of the terminal device and the network device in embodiments of this application.

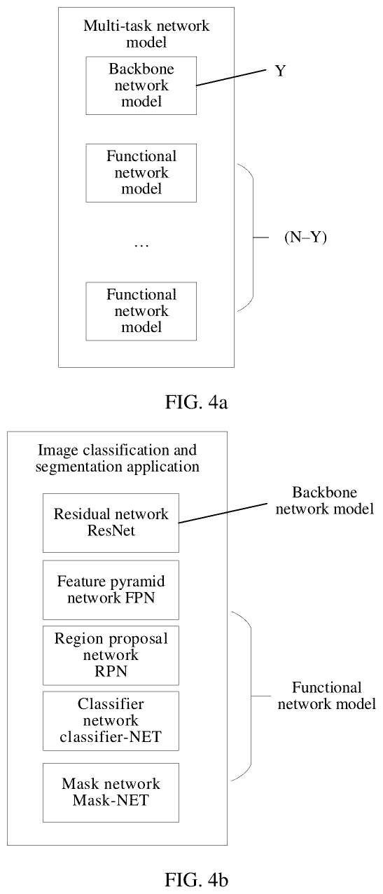

When the two ends that cooperatively run the multi-task network model are the terminal device and the network device, the multi-task network model-based communication method is applicable to an architecture of a communication system. As shown in FIG. 2, the architecture of the communication system includes a network device 201 and a terminal device 202. It may be understood that, in FIG. 2, that there is one network device 201 and one terminal device 202 is used as an example for illustration. There may be a plurality of network devices 201 and a plurality of terminal devices 202. The network device 201 provides wireless access for one or more terminal devices 202 in a coverage area of the network device 201. There may be an overlapping area between coverage areas of the network devices. The network devices may further communicate with each other. The network device 201 provides a service for the terminal device 202 in the coverage area. The network device 201 provides wireless access for one or more terminal devices 202 in the coverage area of the network device 201.

The network device 201 is a node in a radio access network (RAN), and may also be referred to as a base station, or may be referred to as a RAN node (or a device). Currently, some examples of the network device 201 are a next-generation NodeB (gNB), a next-generation evolved NodeB (Ng-eNB), a transmission reception point (TRP), an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), or a wireless fidelity (Wi-Fi) access point (AP). The network device 201 may alternatively be a satellite, and the satellite may also be referred to as a high-altitude platform, a high-altitude aircraft, or a satellite base station. Alternatively, the network device 201 may be another device that has a function of the network device. For example, alternatively, the network device 201 may be a device that has a function of a network device in device-to-device (D2D) communication, internet of vehicles, or machine-to-machine (M2M) communication. Alternatively, the network device 201 may be any possible network device in a future communication system. In some deployments, the network device 201 may include a central unit (CU) and a distributed unit (DU). The network device may further include an active antenna unit (AAU). The CU implements some functions of the network device, and the DU implements some other functions of the network device. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a media access control (MAC) layer, and a physical (PHY) layer. The AAU implements some physical layer processing functions, radio frequency processing, and a function related to an active antenna. Information at the RRC layer is eventually converted into information at the PHY layer, or is converted from information at the PHY layer. Therefore, in this architecture, higher layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (RAN), or the CU may be classified into a network device in a core network (CN). This is not limited in this application.

The terminal device 202 is also referred to as user equipment (UE), a mobile station (MS), a mobile terminal (MT), or the like, and is a device that provides a user with a voice and/or data connectivity. For example, the terminal device 202 includes a handheld device, a vehicle-mounted device, and the like that have a wireless connection function. If the terminal device 202 is located in a vehicle (for example, placed in the vehicle or installed in the vehicle), the terminal device 202 may be considered as a vehicle-mounted device, and the vehicle-mounted device is also referred to as an on board unit (OBU). Currently, the terminal device 202 may be a mobile phone, a tablet computer, a notebook computer, a palmtop computer, a mobile internet device (MID), a wearable device (for example, a smart watch, a smart band, or a pedometer), a vehicle-mounted device (for example, the vehicle-mounted device on an automobile, a bicycle, an electric vehicle, an aircraft, a ship, a train, or a high-speed train), a virtual reality (VR) device, an augmented reality (AR) device, a wireless terminal in industrial control, a smart home device (for example, a refrigerator, a television, an air conditioner, or an electricity meter), an intelligent robot, a workshop device, a wireless terminal in self driving, a wireless terminal in remote medical surgery, a wireless terminal in a smart grid, a wireless terminal in transportation safety, a wireless terminal in a smart city, a wireless terminal in a smart home, a flight device (for example, an intelligent robot, a hot balloon, an uncrewed aerial vehicle, or an aircraft), or the like. Alternatively, the terminal device 202 may be another device that has a function of the terminal device. For example, the terminal device 202 may be a device that has a function of a terminal device in device-to-device (D2D) communication, internet of vehicles, or machine-to-machine (M2M) communication. Particularly, when communication is performed between network devices, a network device that has a function of the terminal device may also be considered as the terminal device.

By way of example but not limitation, in embodiments of this application, the terminal device 202 may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement all or a part of functions without depending on smartphones, for example, smart watches or smart glasses, and include devices that dedicated to only one type of application function and need to collaboratively work with other devices such as smartphones, for example, various smart bands, smart helmets, or smart jewelry for monitoring physical signs.

In embodiments of this application, an apparatus configured to implement a function of the terminal device 202 is, for example, a chip, a radio transceiver, or a chip system. The apparatus configured to implement the function of the terminal device 202 may be installed, disposed, or deployed in the terminal device 202.

To help a person skilled in the art better understand the solutions provided in embodiments of this application, several concepts or terms in this application are first explained and described.

(1) Network Model

The network model may also be referred to as a neural network model, an artificial neural network (ANN) model, a neural network (NN) model, or a connection model. The neural network model can be used to implement an artificial intelligence (AI) technology. Various AI models are used in the AI technology, and different AI models may be used in different application scenarios. The neural network model is a typical representative of the AI model. The neural network model is a mathematical calculation model that imitates a behavior feature of a human brain neural network and performs distributed parallel information processing. A main task of the neural network model is to build a practical artificial neural network based on an application requirement by referring to a principle of the human brain neural network, implement a learning algorithm design suitable for the application requirement, simulate an intelligent activity of the human brain, and then resolve practical problems technically. The neural network implements, based on complexity of a network structure, a corresponding learning algorithm design by adjusting an interconnection relationship between a large quantity of internal nodes.

One neural network model may include a plurality of neural network layers with different functions, where each layer includes a parameter and a calculation formula. Different layers in the neural network model have different names based on different calculation formulas or different functions. For example, a layer for convolution calculation is referred to as a convolution layer, and the convolution layer is usually used to perform feature extraction on an input signal (for example, an image). One neural network model may alternatively include a combination of a plurality of existing neural network submodels. Neural network models of different structures may be used for different scenarios (for example, classification and recognition) or provide different effects when used for a same scenario. That structures of neural network models are different is mainly reflected in one or more of the following: quantities of network layers in the neural network models are different, sequences of the network layers are different, and weights, parameters, or calculation formulas of the network layers are different. The neural network may include a neuron. The neuron may be an operation unit that uses xₛ and an intercept of 1 as an input. An output of the operation unit may be shown as a formula (1):

h_{W,b}(x)=f(W^{T}x)=f(Σₛ₌₁ⁿWₛxₛ+b) (1)

s=1, 2, . . . , and n, n is a natural number greater than 1, Wₛ is a weight of xₛ, and b is a bias of the neuron. f is an activation function of the neuron, and is used to introduce a nonlinear feature into the neural network, to convert the input signal in the neuron into an output signal. The output signal of the activation function may be used as an input of a next convolution layer, and the activation function may be a sigmoid function, a ReLU function, a tan h function, or the like. The neural network is a network formed by connecting a plurality of single neurons together. To be specific, an output of a neuron may be an input of another neuron. An input of each neuron may be connected to a local receptive field of a previous layer to extract a feature of the local receptive field. The local receptive field may be a region including several neurons.

A multilayer perceptron (MLP) is one of feedforward neural network models. The MLP includes a plurality of network layers with different functions: one input layer, one output layer, and one or more hidden layers. The one or more hidden layers are located between the input layer and the output layer, and a quantity of the hidden layers in the MLP may be determined based on an application requirement. In the MLP, information is transmitted unidirectionally, that is, information starts to move forward from the input layer, then is transmitted layer by layer in the one or more hidden layers, and then is transmitted from the last hidden layer to the output layer.

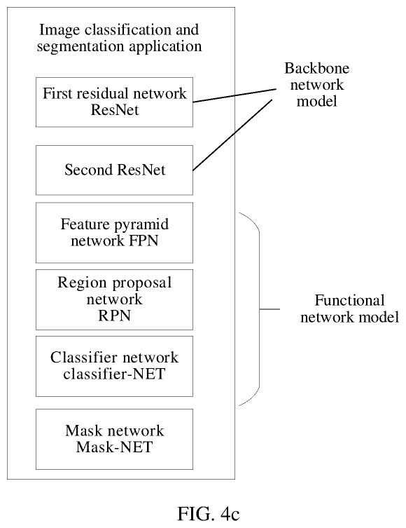

FIG. 3 shows an example of a structure of the neural network model.

As shown in FIG. 3, the input layer includes a plurality of neurons. The neuron at the input layer is also referred to as an input node. The input node is configured to receive an input vector input from the outside, and transfer the input vector to a neuron at a hidden layer connected to the input node. The input node does not perform a calculation operation.

As shown in FIG. 3, the hidden layer includes a plurality of neurons. The neuron at the hidden layer is also referred to as a hidden node. The hidden node is configured to extract a feature of an input vector based on the input vector input to the hidden layer, and transfer the feature to a neuron at a lower layer. In addition, an implementation of extracting the feature by the hidden node is: determining an output vector of the hidden node based on an output vector of a neuron located at an upper layer and a weight value of a connection between the hidden node and the neuron at the upper layer and according to an input/output relationship of the hidden node. The upper layer is a network layer that sends input information to the hidden layer at which the hidden node is located, and the lower layer is a network layer that receives output information of the hidden layer at which the hidden node is located.

As shown in FIG. 3, the output layer includes one or more neurons. The neuron at the output layer is also referred to as an output node. The output node may determine an output vector of the output node based on an input/output relationship of the output node, an output vector of a hidden node connected to the output node, and a weight value between the hidden node connected to the output node and the output node, and transfer the output vector to the outside.

Adjacent layers of the multilayer perceptron are fully connected, that is, for any two adjacent layers, any neuron at an upper layer is connected to all neurons at a lower layer. In addition, weights are configured for connections between neurons at adjacent layers.

(2) Multi-Task Network Model

The multi-task network model is a network model used in an MTL mode. Compared with a single-task network model used in an STL mode, the multi-task network model can execute a plurality of tasks. The multi-task network model may include a plurality of sub-network models. For example, the multi-task network model includes N sub-network models, and each sub-network model may be considered as the neural network model described in the foregoing (1). The N sub-network models included in the multi-task network model may be classified into a backbone network model and a functional network model. The functional network model may be used to be responsible for a task, a plurality of functional network models may be used to be responsible for a plurality of tasks, the plurality of tasks may be correlated, and the plurality of functional network models may share a backbone network model.

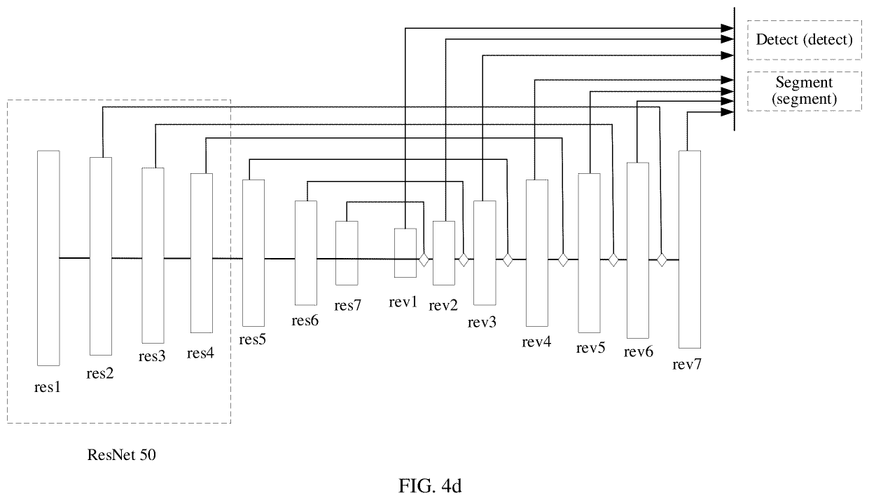

The backbone network model may be used to extract a feature. For example, network models such as a residual network (ResNet), a visual geometry group (VGG), a mobile network (mobileNet), a Google innovation network (GoogLeNet), or an Alex network (AlexNet, e.g., Alex is a name of a person) each have a feature extraction capability, and therefore may be used as the backbone network model. The functional network model may be used to be responsible for another function. As shown in FIG. 4a, the N sub-network models include Y backbone network models and (N-Y) functional network models, where Y is a positive integer, and 1≤Y≤N. For example, when a value of Y is 1, the N sub-network models include one backbone network model and (N−1) functional network models. Alternatively, the multi-task network model may have only one model type, that is, the backbone network model. It may also be considered that the multi-task network model includes one sub-network model, or the multi-task network model cannot be divided into a plurality of sub-network models, and the backbone network model in the multi-task network model executes a plurality of related tasks.

A CNN is widely used in the computer vision field. For example, tasks such as detection, tracking, recognition, classification, or prediction can be resolved by using a corresponding network model established by using the CNN. The following uses several tasks applied to the CNN multi-task model as an example to describe the multi-task model.

For example, as shown in FIG. 4b, the multi-task network model is used for an image classification and segmentation application. Specifically, the image classification and segmentation application is a mask region-based convolutional neural network (Mask-RCNN). The multi-task network model includes five sub-network models, including one backbone network model and four functional network models. The five sub-network models are ResNet, FPN, RPN, Classifier-NET, and Mask-NET. ResNet is the backbone network model and is used as a feature extractor. FPN, RPN, Classifier-NET, and Mask-NET are the functional network models. FPN is used to expand a backbone network and can better represent a target on a plurality of scales. RPN determines a region of interest. Classifier-NET classifies the target. Mask-NET segments the target.

For another example, as shown in FIG. 4c, the multi-task network model is an image classification and segmentation application Mask-RCNN. The multi-task network model includes six sub-network models, including two backbone network models and four functional network models. The two backbone network models are a first ResNet and a second ResNet, and the four functional network models are FPN, RPN, Classifier-NET, and Mask-NET. The first ResNet is used for feature extraction, and the second ResNet is used for further feature extraction on a result obtained after the feature extraction of the first ResNet. FPN is used to expand a backbone network and can better represent a target on a plurality of scales. RPN determines a region of interest. Classifier-NET classifies the target. Mask-NET segments the target.

For another example, as shown in FIG. 4d, the multi-task network model is applied to a computer vision task. Target detection and semantic segmentation are two related tasks, and both are used to recognize and classify an object in an image. The two tasks of target detection and semantic segmentation may be respectively performed by using two functional network models. A detection (detect) functional network model is used to perform the target detection task, and a segmentation (segment) functional network model is used to perform the semantic segmentation task. The backbone network model may include a ResNet 50 model, a plurality of CNN layers, and a residual connection. In FIG. 4d, the rectangular bar may be represented as an intermediate feature, the horizontal line without an arrow above the rectangular bar is a residual connection, and a plurality of intermediate features obtained through feature extraction each need to be transmitted to a rear-end diamond through the residual connection for operation. The diamond represents an operation, and may be used to fuse intermediate features of different scales at different locations of a backbone network by using a series of sampling operations and convolution operations, to obtain a new feature. The line with an arrow above the rectangular bar represents that a processing result of the operation represented by the diamond is output and that the processing result is output to the detection (detect) functional network model and the segmentation (segment) functional network model.

It can be seen that the backbone network model in the CNN multi-task network model has a complex structure and a large quantity of parameters. If the multi-task network model is applied to a cooperative running scenario (for example, device-cloud collaboration), a part of the multi-task network model needs to run at one of two ends that cooperatively run, and the other part needs to run at the other of the two ends that cooperatively run. It may be understood that the multi-task network model needs to be divided to form two parts. However, based on FIG. 4d, it can be learned that the backbone network model of the CNN multi-task network model has the complex structure, and there is no clear dividing point that can divide the multi-task network model into the two parts. In addition, it can be learned from FIG. 4d that the CNN multi-task network model has the large quantity of parameters, and the intermediate feature further needs to be transmitted from one end to the other end in the coordinative running scenario. Generally, a dimension of the intermediate feature that needs to be transmitted is not only large, but also redundant. In conclusion, how to implement cooperative running of the multi-task network model is a problem that needs to be resolved.

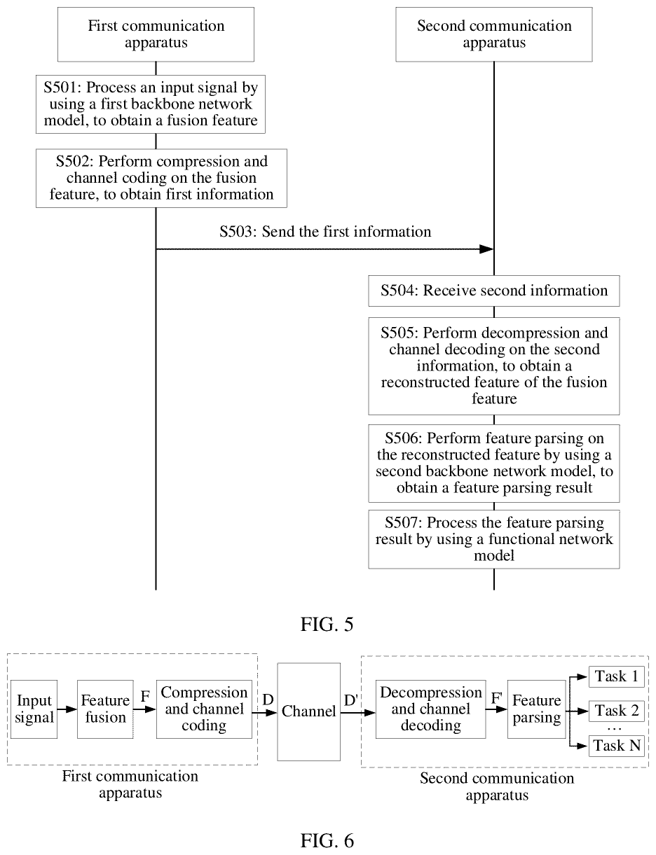

Based on this, an embodiment of this application provides a multi-task network model-based communication method, to implement cooperative running of the multi-task network model. As shown in FIG. 5, a specific procedure of the multi-task network model-based communication method provided in this embodiment of this application is as follows. The multi-task network model may include a first backbone network model, a second backbone network model, and a functional network model. The first backbone network model runs on a first communication apparatus, and the second backbone network model and the functional network model run on a second communication apparatus. It may be understood that the first backbone network model and the second backbone network model may be of a same model type. For example, the first backbone network model and the second backbone network model are ResNet. The first backbone network model and the second backbone network model may be two parts of one backbone network model, or may be considered as two independent backbone network models. There may be one or more first backbone network models and one or more second backbone network models.
S501: The first communication apparatus processes an input signal by using the first backbone network model, to obtain a fusion feature.

The fusion feature is obtained by fusing a plurality of first features, and plurality of first features are obtained by performing feature extraction on the input signal.
S502: The first communication apparatus performs compression and channel coding on the fusion feature, to obtain first information.
S503: The first communication apparatus sends the first information to the second communication apparatus.
S504: The second communication apparatus receives second information from the first communication apparatus.

It may be understood that the first information is affected by channel noise during channel transmission, and the second information is information obtained after the first information is affected by the noise. In an ideal case in which there is no impact of the channel noise, the second information is the same as the first information.
S505: The second communication apparatus performs decompression and channel decoding on the second information, to obtain a reconstructed feature of the fusion feature.

The fusion feature is obtained by fusing a plurality of first features obtained by performing feature extraction on the input signal.
S506: The second communication apparatus performs feature parsing on the reconstructed feature by using the second backbone network model, to obtain a feature parsing result.
S507: The second communication apparatus processes the feature parsing result by using the functional network model.

The multi-task network model includes the first backbone network model, the second backbone network model, and the functional network model. The first communication apparatus and the second communication apparatus cooperatively run the multi-task network model. After the input signal is input to the multi-task network model, a processing result obtained after the functional network model processes the feature parsing result is finally output.

The plurality of first features extracted from the input signal are fused, so that the obtained fusion feature can include more information. Therefore, the second communication apparatus can perform more accurate processing on the other part of the network model based on the fusion feature. The fusion feature is generated in a feature extraction phase, so that a structure of the multi-task network model can be clearer. This facilitates the multi-task network model being divided into a part executed by the first communication apparatus and the other part executed by the second communication apparatus, and further facilitates implementing device-cloud collaboration in an MTL mode. In addition, through compression, there are only a few parameters transmitted between the first communication apparatus and the second communication apparatus, so that transmission overheads are reduced. Through channel coding, anti-noise performance of data transmitted between the first communication apparatus and the second communication apparatus can be better achieved.

The following describes some optional implementations of the embodiment in FIG. 5.

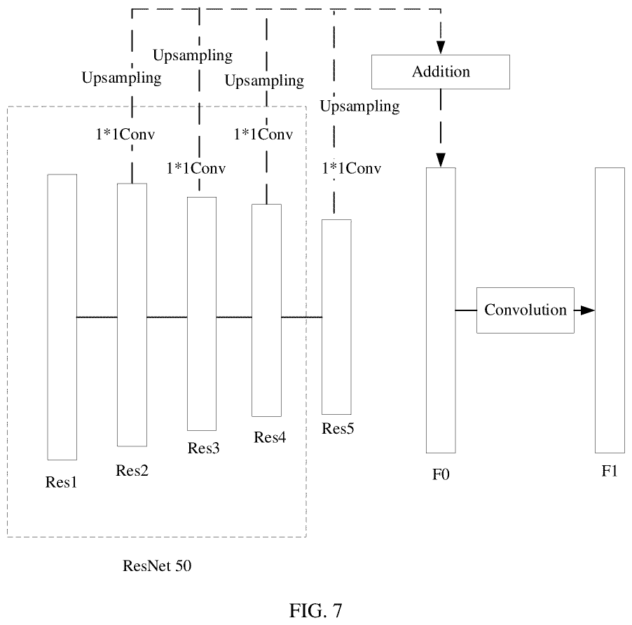

Based on the embodiment in FIG. 5, the following illustrates a process of the multi-task network model-based communication method in FIG. 6. As shown in FIG. 6, the first communication apparatus and the second communication apparatus cooperatively run the multi-task network model. The first communication apparatus processes an input signal by using the first backbone network model, where the input signal may be an image, to obtain a fusion feature F, and the fusion feature F is a three-dimensional tensor. The first communication apparatus performs compression and channel coding on the fusion feature F to obtain first information D. A dimension of the first information D is smaller than a dimension of the fusion feature F, that is, a quantity of elements of D is less than a quantity of elements of F. The first communication apparatus sends the first information D, the first information D is transmitted through a radio channel, and the second communication apparatus receives second information D′ obtained after channel interference is performed on D. The second communication apparatus performs decompression and channel decoding on the second information D′ to obtain a reconstructed feature F′ of F. The second communication apparatus performs feature parsing on the reconstructed feature F′ by using the second backbone network model, to obtain a feature parsing result. The second communication apparatus inputs the feature parsing result to a plurality of functional network models for processing, and the plurality of functional network models share the feature parsing result. For example, N functional network models shown in FIG. 6 respectively correspond to N tasks. The second communication apparatus separately processes the feature parsing result by using the N functional network models, to obtain processing results of the N tasks.

In this embodiment of this application, the task that can be executed by the multi-task network model may be model training or model inference.

The following describes an optional implementation of S501. The first communication apparatus processes the input signal by using the first backbone network model to obtain the fusion feature. The first communication apparatus performs feature extraction on the input signal to obtain a plurality of second features, where the plurality of second features have different feature dimensions. The first communication apparatus processes feature dimensions of the plurality of second features to obtain the plurality of first features having a same feature dimension. The plurality of first features respectively correspond to the plurality of second features. In other words, a first feature corresponding to one second feature may be obtained by processing a feature dimension of the one second feature. The first communication apparatus performs feature fusion on the plurality of first features to obtain the fusion feature.

The feature dimension may include a height, a width, and a channel number. In this embodiment of this application, a feature named by the first feature, the second feature, the third feature, or the like may be an intermediate feature, and the intermediate feature is processing data obtained by a layer in an intermediate processing process of the multi-task network model.

The plurality of second features are processed to obtain the plurality of first features having the same dimension. A processing process may be: separately performing a convolution operation and an upsampling operation on the plurality of first features, where the convolution operation herein is denoted as a first convolution operation. A sequence of the first convolution operation and the upsampling operation is not limited. The first convolution operation may change a channel number of the feature, and the upsampling operation may change a height and a width of the feature. The upsampling operation may be performed to separately change a height and a width of the first feature to any value, which is not limited to an integer multiple. For example, eight times or more of an original height may be expanded, and an expansion multiple is any multiple. In a conventional operation, if a deconvolution operation is performed to change a height and a width of a feature, an expansion multiple can only be twice, and the expansion multiple needs to be an integer. Compared with the conventional operation, the upsampling operation expands the multiple of the dimension more flexibly.

The upsampling operation may also be referred to as an interpolation operation, and an objective is to enlarge the height and/or the width of the feature. A process of the upsampling operation or the interpolation operation may be: rescaling (rescale) an input feature to a target size, calculating a feature value of each sampling point, and performing interpolation on another point by using an interpolation method, for example, bilinear interpolation. Interpolation is to calculate a missing value based on a neighboring feature value according to a mathematical formula and insert the missing value obtained through calculation.

Performing feature fusion on the plurality of first features to obtain the fusion feature may be performing an addition operation on the plurality of first features to obtain the fusion feature. Alternatively, addition is performed on the plurality of first features to obtain a third feature, and then a second convolution operation is performed on the third feature to obtain the fusion feature. Performing addition on the plurality of first features may be separately performing addition on elements at a same location of the plurality of first features. The intermediate feature may be three-dimensional data having a height, a width, and a channel number. The same location of the plurality of first features refers to a same height, a same width, and a same channel location of the plurality of first features.

The following describes, with reference to a specific application scenario, a process in which the first communication apparatus fuses the plurality of first features to obtain the fusion feature.

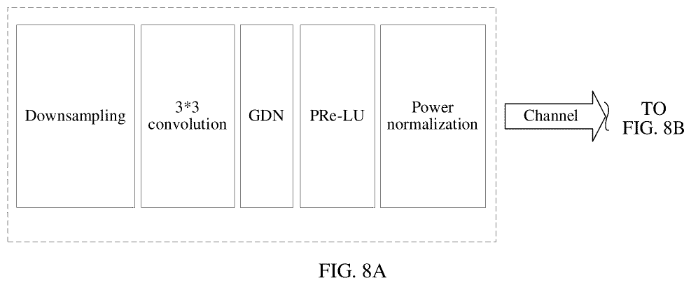

As shown in FIG. 7, the first backbone network model is a residual network 50 (ResNet 50), and the ResNet 50 is a residual network having 50 convolution layers. The first communication apparatus performs feature extraction on an input signal by using the ResNet 50, to obtain a plurality of second features having different feature dimensions. The different feature dimensions may refer to different heights, widths, and channel numbers. The plurality of second features are denoted as Res1, Res2, Res3, Res4, and Res5, and feature dimensions of Res1, Res2, Res3, Res4, and Res5 are respectively denoted as (H1, W1, C1), (H2, W2, C2), (H3, W3, C3), (H4, W4, C4), (H5, W5, C5). H indicates the height, W indicates the width, and C indicates the channel number. A relationship between the feature dimensions is as follows: H1>H2>H3>H4>H5, W1>W2>W3>W4>W5, C1<C2<C3<C4<C5, and H1*W1*C1>H2*W2*C2>H3*W3*C3>H4*W4*C4>H5*W5*C5. The first communication apparatus separately performs a 1*1 convolution operation on Res2, Res3, Res4, and Res5, changes feature channel numbers of Res2, Res3, Res4, and Res5, and changes heights and widths of Res2, Res3, Res4, and Res5 by using an upsampling method. Finally, Res2, Res3, Res4, and Res5 are unified as a same feature dimension, and the same feature dimension is denoted as (H, W, C), that is, Res2, Res3, Res4, and Res5 are unified into four groups of first features whose dimensions are all (H, W, and C). It should be noted that, if a dimension of one or more features in Res2, Res3, Res4, and Res5 is the same as the unified same feature dimension, no convolution operation and upsampling needs to be performed on the one or more features. For example, assuming that a dimension of the Res2 feature is the same as the unified same feature dimension, no convolution operation and upsampling needs to be performed on Res2, and a convolution operation and upsampling only need to be performed on Res3, Res4, and Res5. The first communication apparatus performs element-by-element addition on the four groups of first features to obtain a third feature F0. The first communication apparatus performs a 3*3 convolution operation on the third feature F0 to obtain a fusion feature F1. A convolution kernel that performs a convolution operation on the third feature F0 may change to another value, and is generally an odd number, provided that a size of the convolution kernel is less than or equal to a width and/or a height of F0. The convolution operation is represented by conv in the figure.

The following describes an optional implementation of S502. The first communication apparatus performs compression and channel coding on the fusion feature to obtain the first information. Compression and channel coding may be understood as joint source-channel coding (JSCC), and may be implemented based on a joint source-channel coding model. The joint source-channel coding model is trained based on channel noise, and data processed by using the joint source-channel coding model has anti-noise performance. The first communication apparatus inputs the fusion feature to the JSCC model, to output the first information. The first communication apparatus performs downsampling and a third convolution operation on the fusion feature by using the joint source-channel coding model, to obtain a fourth feature. The downsampling operation may also be referred to as subsampling. The downsampling can enable a feature obtained after the downsampling to meet a size of a display area. The downsampling can also generate a thumbnail of the downsampled feature. A process of the downsampling may be described as follows. For a group of features whose heights and widths are MN, the downsampling is performed on the features by s times to obtain a resolution of (M/s)*(N/s) sizes, where s is a common divisor of M and N. If the downsampled feature is a feature in a matrix form, feature values in an s*s window of the downsampled original feature may be converted into one value, and the one value is an average value of all feature values in the window. The downsampling may reduce the fusion feature to any dimension, that is, the downsampling operation may reduce the fusion feature to any height and any width, provided that a value of the height or a value of the width after the downsampling is a positive integer. For example, the downsampling may reduce a height and a width of the fusion feature. When both the height and the width of the fusion feature are 64, the downsampling is used to reduce the height and the width of the fusion feature to 16, that is, 4×4=16 times compression of the feature is implemented. In a normal case, when the convolution operation is used to reduce the height and the width of the fusion feature, a multiple of a dimension reduced by the convolution operation is affected by a size of a convolution kernel, and can be reduced only to one of an integer multiple of an original dimension. In comparison, the dimension of the fusion feature can be reduced more flexibly in the downsampling manner.

The third convolution operation can reduce a feature channel number of the fusion feature. The third convolution operation may be a 3*3 convolution operation. The convolution operation can adjust a ratio of a quantity of output channels to a quantity of input channels based on a specific requirement, to implement different compression multiples. A channel number of an input feature of the third convolution operation may be any positive integer, and the third convolution operation may control a quantity of output channels, to reduce the feature channel number.

The first communication apparatus may further perform one or more of the following operations on the fourth feature by using the joint source-channel coding model: generalized divisive normalization (GDN), a parametric rectified linear unit (PReLU), or power normalization. The GDN operation may be used to improve a compression capability of the joint source-channel coding model. The PReLU may also be used to improve the compression capability of the joint source-channel coding model. A further compression effect on the fourth feature can be implemented by using the GDN operation and the PReLU operation. The power normalization may make a power of a compressed result be 1.

Optionally, the foregoing operations of the joint source-channel coding model are merely examples. In actual application, some other operations that can achieve same effect may be used for replacement. For example, the GDN operation can be replaced with batch normalization (BN). For another example, the PReLU may be replaced with rectified linear unit (ReLU) or leaky rectified linear unit (Leaky ReLu).

The following describes an optional implementation of S505. The second communication apparatus performs decompression and channel decoding on the second information to obtain the reconstructed feature of the fusion feature.

Decompression and channel decoding may be understood as joint source-channel decoding, and may be implemented based on a joint source-channel decoding model. In other words, the second information is input to the joint source-channel decoding model, to output the reconstructed feature of the fusion feature. The second communication apparatus performs the following operations on the second information by using the joint source-channel decoding model: a first convolution operation, an upsampling operation, and a second convolution operation. A spatial dimension of the feature can be restored through the upsampling operation. Because the first communication apparatus reduces the height and the width of the fusion feature through the downsampling operation during compression and coding, and a reduction multiple may be any value, the second communication apparatus herein can restore the height and the width of the feature through the corresponding upsampling operation, and an expanded dimension of the upsampling is also flexible, and the spatial dimension of the feature can be restored by using a multiple corresponding to the upsampling.

For example, on the first communication apparatus side, an original feature channel number of the fusion feature is 64, and the feature channel number of the fusion feature is reduced to 1 through the third convolution operation. The feature channel number that is of the second information and that is obtained by the second communication apparatus is 1. The feature channel number is restored to 8 through the first convolution operation, and the feature channel number is restored to 64 through the second convolution operation. Compared with one convolution operation, when two convolution operations of the first convolution operation and the second convolution operation are used, the compressed fusion feature can be slowly restored, and a feature restoration capability is improved. Therefore, the restored reconstructed feature has more parameters, and using the more parameters can improve parsing accuracy of the network model.

That the second communication apparatus performs decompression and channel decoding on the second information further includes one or more of the following operations: inverse generalized divisive normalization (IGDN), a parametric rectified linear unit (PReLU), batch normalization (BN), or a rectified linear unit (ReLU). The IGDN may be used to improve a decompression capability or a decoding capability of the joint source-channel decoding model. The PReLU may also be used to improve the decompression capability or the decoding capability of the joint source-channel decoding model. The BN and/or the ReLU may limit a range of a decoding result, and may further increase accuracy of the decoding result.

After decompression and channel decoding, the second communication apparatus obtains the reconstructed feature of the fusion feature. The reconstructed feature and the fusion feature have a same dimension size. When coding and decoding performance is ideal, the reconstructed feature is the fusion feature.

Optionally, the foregoing operations of the joint source-channel decoding model are merely examples. In actual application, some other operations that can achieve same effect may be used for replacement. For example, the IGDN may be replaced with the BN. It may be understood that the joint source-channel decoding process performed by the second communication apparatus corresponds to the joint source-channel coding process performed by the first communication apparatus. In other words, if the GDN is used during coding, the IGDN is used during decoding. If the BN is used on the coding side, corresponding BN is used on the decoding side.

For another example, the PReLU may be replaced with the ReLU or the Leaky ReLU.

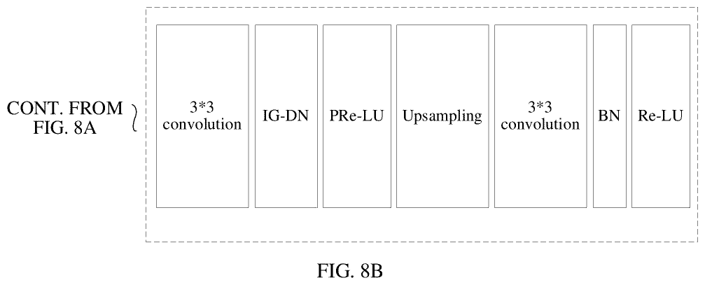

The following describes, by using an example based on FIG. 8A and FIG. 8B, steps of joint source-channel coding and decoding. The first communication apparatus performs the following operations on the fusion feature during coding: downsampling, a 3*3 convolution operation, GDN, a PReLU, and power normalization, to obtain first information. After the first information is transmitted through a channel, the second communication apparatus receives second information corresponding to the first information after the first information is transmitted through the channel. The second communication apparatus performs the following operations on the second information during decoding: a 3*3 convolution operation, IGDN, a PReLU, upsampling, a 3*3 convolution operation, BN, and a ReLU, to obtain a reconstructed feature of the fusion feature.

The second communication apparatus needs to perform feature parsing on the reconstructed feature, to obtain a feature parsing result. The feature parsing result includes X features, a 1^{st} feature in the X features is the reconstructed feature, and an (Xᵢ₊₁)^{th} feature in the X features is obtained through an operation on an Xᵢ^{th} feature; first Y features in the X features are obtained through a first operation, and last (X-Y) features in the X features are obtained through a second operation; and X, Y, and i are positive integers, i is less than or equal to X, and Y is less than or equal to X.

Different features in the X features have different heights and widths, but channel numbers are the same. For example, a height of the Xᵢ₊₁^{th} feature is ½ of a height of the Xᵢ^{th} feature, a width of the Xᵢ₊₁^{th} feature is ½ of a width of the Xᵢ^{th} feature, and a channel number the Xᵢ₊₁^{th} feature is the same as a channel number the Xᵢ^{th} feature.

A convolution operation in the first operation has a plurality of receptive fields, and a convolution operation in the second operation has one receptive field. Convolution results of different receptive fields are fused together, and is a feature fusion means. In the feature fusion means, different information is extracted and fused from different angles, so that a result of the first operation includes more information than a result of the second operation. This helps improve performance of the functional network model.

Optionally, a convolution operation having a first convolution kernel in the second operation has a first receptive field, and a convolution operation having a same first convolution kernel in the first operation has two receptive fields. The two receptive fields include a first receptive field and a second receptive field, and the second receptive field is greater than the first receptive field.

The second operation may be a bottleneck module, and the first operation may be a dilated bottleneck module.

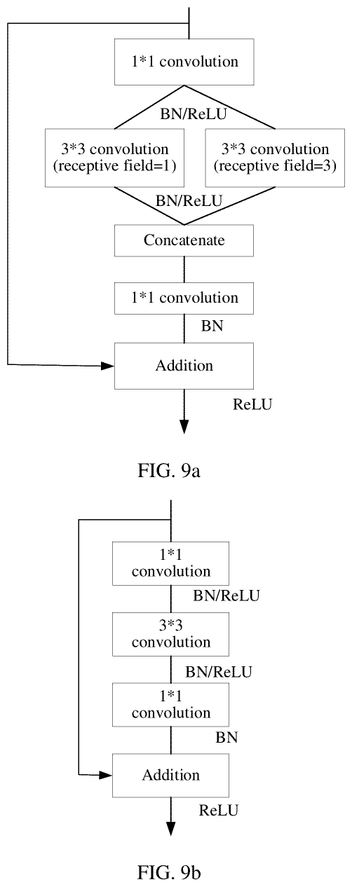

Optionally, as shown in FIG. 9a, the first operation may include the following operations: performing a 1×1 convolution operation (conv) on a to-be-processed feature in the first Y features; separately performing a plurality of 3×3 convolution operations on a result of the 1×1 convolution operation, where the plurality of 3×3 convolution operations have different receptive field sizes; performing channel number dimension concatenation (contat) on a result of the plurality of 3×3 convolution operations; performing the 1×1 convolution operation on a result obtained through the channel number dimension concatenation, to obtain a first convolution result; and performing element-by-element addition the first convolution result and the to-be-processed feature. The to-be-processed feature in the first Y features is any feature in the first Y features, and such an operation may be performed on each of the first Y features. Optionally, the BN and/or the ReLU may be further performed after the 1×1 convolution operation is performed for the first time, and the BN and/or the ReLU may be further performed after the plurality of 3×3 convolution operations are performed. The BN may be further performed after the lxi convolution operation is performed for the second time. After element-by-element addition is performed on the first convolution result and the to-be-processed feature, the ReLU may be further performed.

As shown in FIG. 9b, the second operation may include the following operations: performing a 1×1 convolution operation on a to-be-processed feature in last (X-Y) features in the X features; performing a 3×3 convolution operation on a result of the 1×1 convolution operation; performing a lxi convolution operation on the result of the 3×3 convolution operation, to obtain a second convolution result; and performing element-by-element addition on the second convolution result and the to-be-processed feature in the last (X-Y) features. The to-be-processed feature in the last (X-Y) features in the X features is any one of the last (X-Y) features, and such an operation may be performed on each of the last (X-Y) features. Optionally, the BN and/or the ReLU may be further performed after the lxi convolution operation is performed for the first time, and the BN and/or the ReLU may be further performed after the 3×3 convolution operation is performed. The BN may be further performed after the lxi convolution operation is performed for the second time. After element-by-element addition is performed on the second convolution result and the to-be-processed feature, the ReLU may be further performed.

The following describes, with reference to a specific application scenario, a process in which the second communication apparatus performs feature parsing on the reconstructed feature.

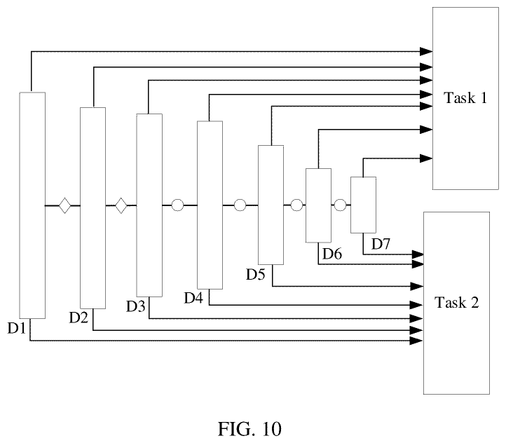

As shown in FIG. 10, the reconstructed feature is represented by D1, and the second communication apparatus performs feature parsing on the reconstructed feature D1 by using a second backbone network model, to obtain X features having different feature dimensions, where X=7. The seven features include D1, and further include D2, D3, D4, D5, D6, and D7. A feature dimension of D1 is the same as a feature dimension of the fusion feature, for example, denoted as (H, W, C). H indicates the height, W indicates the width, and C indicates the channel number. It is assumed that a height of an Xᵢ₊₁^{th} feature is ½ of a height of an Xᵢ^{th} feature, a width of the Xᵢ₊₁^{th} feature is ½ of a width of the Xᵢ^{th} feature, and a channel number the Xᵢ₊₁^{th} feature is the same as a channel number the Xᵢ^{th} feature. Feature dimensions of D1 to D7 are (H, W, C), (H1/2, W/2, C), (H/4, W/4, C), (H1/8, W/8, C), (H/16, W/16, C), (H/32, W/32, C), and (H/64, W/64, C). Each feature is generated based on a previous feature. Because the height and the width of the feature become smaller, a height and a width of the front feature in the X features are greater than those of the later feature. First Y features in the X features may be obtained by performing the first operation, and last (X-Y) features in the X features are obtained by performing the second operation. For example, in FIG. 10, the first operation is represented by a diamond, and the second operation is represented by a circle. First three features among the seven features are obtained through the first operation, and last four features among the seven features are obtained through the second operation. The seven features D1 to D7 are output to functional network models, and are shared by a plurality of functional network models of a plurality of tasks. In FIG. 10, two tasks (a task 1 and a task 2) are used as an example.

In this embodiment of this application, model training needs to be performed before the multi-task network model is applied, and model training also needs to be performed before the joint source-channel coding model and the joint source-channel decoding model are applied. In an optional implementation, it may be considered that the multi-task network model may include the joint source-channel coding model and the joint source-channel decoding model. Certainly, it may also be considered that the multi-task network model and the joint source-channel coding model and the joint source-channel decoding model are mutually independent models. Generally, the joint source-channel coding model and the joint source-channel decoding model are combined for training. The following describes a possible implementation process of model training.

Step 1: Generate a basic multi-task network model, where the multi-task network model may be applied to a collaborative running scenario, for example, may be applied to a device-cloud collaboration scenario. Two apparatuses that cooperatively run may still be represented by the first communication apparatus and the second communication apparatus.

Step 2: Initialize a network parameter of the multi-task network model, where input training data is an image pixel value standardized to an [0, 1] interval; input features obtained after feature extraction and feature parsing to a functional network model corresponding to each task branch to complete a corresponding task; and output a result.

A loss is calculated based on the output of each task branch and labeling information in the training data, to implement end-to-end training on the multi-task network model. A multi-task loss function L_{MTL} is defined as: L_{MTL}=L_{Task1}+L_{Task2}+ . . . +L_{TaskN}. Task1, Task2, . . . , and TaskN are used to represent N tasks. The multi-task loss function is a sum of loss functions of all task branches.

Step 2 is repeated until the multi-task network model converges.

Step 3: Based on the converged multi-task network model, select a dividing point to divide the network model into two parts, and add a joint source-channel coding model and a joint source-channel decoding model to simulate a process of compressing, transmitting, decompressing, and reconstructing an intermediate feature.

Parameters of the joint source-channel coding model and the joint source-channel decoding model are initialized. A compression result obtained after the joint source-channel coding model compresses the intermediate feature is used to simulate a transmission process on the channel by using a channel model, for example, an AWGN channel or a Rayleigh channel.

Parameters of the trained multi-task network model are fixed, and only a newly added joint source-channel coding model and a newly added joint source-channel decoding model are trained. A loss function is: L_{MTL}+L1(F, F′), where L_{MTL} is a multi-task loss function, and L1(F, F′) is an L1-norm of an original intermediate feature F and a reconstructed intermediate feature F′.

Step 3 is repeated until the joint source-channel coding model and the joint source-channel decoding model converge.

Step 4: Based on the training result in step 3, the parameters of the multi-task network model are no longer fixed, and end-to-end joint training is performed on all parameters of the multi-task network model to which the joint source-channel coding model and the joint source-channel decoding model have been added, where a used loss function is L_{MTL}, and step 4 is repeated until the overall model converges. The overall model is the multi-task network model, the joint source-channel coding model, and the joint source-channel decoding model. The joint source-channel coding model and the joint source-channel decoding model may be briefly referred to as a codec model.

In the foregoing model training method, the overall model is trained step by step. First, the multi-task network model is trained as a basic model of an overall framework, and then the joint source-channel coding model and the joint source-channel decoding model are separately trained to obtain the codec model having a specific compression capability. Finally, end-to-end training is performed on the overall model, so that the multi-task network model, the joint source-channel coding model, and the joint source-channel decoding model are more closely coupled, and overall performance is further improved. A sum of the multi-task loss function and the L1-norm before and after the intermediate feature is compressed and reconstructed are used as a loss function for independently training the codec model, so that the codec model improves system performance while ensuring the compression capability.

The following describes, by using a table, performance improvement of the multi-task network model compared with another network model provided in this embodiment of this application.

As shown in Table 1, the multi-task network model provided in this embodiment of this application is represented by a feature fusion based multi-task network (FFMNet), and another multi-task network model is BlitzNet. mAP is an average accuracy mean, and is an accuracy measurement indicator of a target detection branch. mIoU is an average intersection-and-parallel ratio, and is an accuracy measurement indicator of a semantic segmentation branch. Param is a model parameter quantity indicator, and an order of magnitude is millions (M). Compared with BlitzNet, FFMNet has higher performance and fewer parameters.

TABLE 1

| Network model | mAP (%) | mIoU (%) | Param |
|---|---|---|---|
| FFMNet | 40.8 | 44.6 | 63.2M |
| BlitzNet | 40.1 | 44.1 | 87.8M |

As shown in Table 2, compared with a single-task network model, the multi-task network model FFMNet provided in this embodiment of this application has higher performance. Table 2 shows a plurality of versions of FFMNets. A FFMNet 1 is a network model with functions of target detection and semantic segmentation. A FFMNet 2 is only a functional network model, that is, a single-task network model, and the functional network model is a functional network model for target detection. A FFMNet 3 is only a functional network model, that is, a single-task network model, and the functional network model is a functional network model for semantic segmentation.

TABLE 2

| | Det (target | Seg (semantic | | |
|---|---|---|---|---|
| | detection | segmentation | | |
| Network | branch | branch | mAP | mIoU |
| model | sub-network model) | sub-network model) | (%) | (%) |
| FFMNet 1 | ✓ | ✓ | 40.8 | 44.6 |
| FFMNet 2 | ✓ | | 40.3 | — |
| FFMNet 2 | | ✓ | — | 40.4 |

In Table 2, √ indicates that the FFMNet has the functional network model, and—indicates that the network model cannot test a corresponding indicator.

In an embodiment, the multi-task network model is combined with the codec model, to implement high-time compression on the intermediate feature. As shown in Table 3, training may be performed without noise interference, the codec model can achieve 1024-time compression on the intermediate feature, and performance losses of two task branches (for example, two tasks of target detection and semantic segmentation) are controlled within 2%. The two tasks of target detection and semantic segmentation respectively correspond to two sub-network models or two functional network models.

TABLE 3

| | Compression ratio | | |
|---|---|---|---|
| Feature size | (compression ratio) | mAP (%) | mIoU (%) |
| (H, W, C) | 1 | 40.8 | 44.6 |
| (H/2, W/2, C/32) | 128 times | 40.2 | 43.6 |
| (H/2, W/2, C/64) | 256 times | 39.7 | 43.1 |
| (H/4, W/4, C/32) | 512 times | 39.4 | 43.1 |
| (H/4, W/4, C/64) | 1024 times | 38.8 | 42.8 |

In Table 3, the first line is an original feature dimension (H, W, C), that is, no compression and decompression process is performed. Therefore, a compression ratio is 1, and then performance of two corresponding sub-network models is 40.8/44.6. The second line is a result obtained after the original feature is compressed and decompressed. (H/2, W/2, C/32) indicates a value of the coding result, that is, a height and a width are ½ of those of the original feature, a channel number is 1/32 of that of the original feature, and therefore a compression ratio is 2×2×32=128. A result obtained after a receive end performs feature parsing and executing a functional sub-network after performing decoding is 40.2/43.6. The third line is a result obtained after the original feature is compressed and decompressed. (H/2, W/2, C/64) indicates a value of the coding result, that is, a height and a width are ½ of those of the original feature, a channel number is 1/64 of that of the original feature, and therefore a compression ratio is 2×2×64=256. A result obtained after a receive end performs feature parsing and executing a functional sub-network after performing decoding is 39.7/43.1. For the fourth line and the fifth line, refer to the explanation of the second line.

It can be seen that performance of 1024-time compression and decompression is greatly different from that of non-compression. In actual application, the compression multiple can be set to 512 times to achieve a balance between the compression effect and functional network performance.

Through step-by-step model training, AWGN noise is introduced in the training process when the compression multiple is fixed at 512 times, and finally a joint source-channel codec model that is oriented to a multi-task network and that is with a high compression multiple and a specific anti-noise capability may be obtained.

Compared with a conventional method for compressing the intermediate feature by using a joint photographic experts group (JPEG) with reference to quadrature amplitude modulation (QAM), the joint source-channel coding model provided in this embodiment of this application has a higher compression multiple and overcomes cliff effect of a conventional separation method. JPEG is a lossy compression standard method widely used for photo images. Herein, the fusion feature may be considered as an image having a plurality of channels, and therefore a compression algorithm in the JEPG may be used to perform source coding on the feature. QAM is a modulation mode that performs amplitude modulation on two orthogonal carriers. The two carriers are usually sine waves with a phase difference of 90 degrees (π/2), and therefore are referred to as orthogonal carriers. This is used for channel protection and modulation.

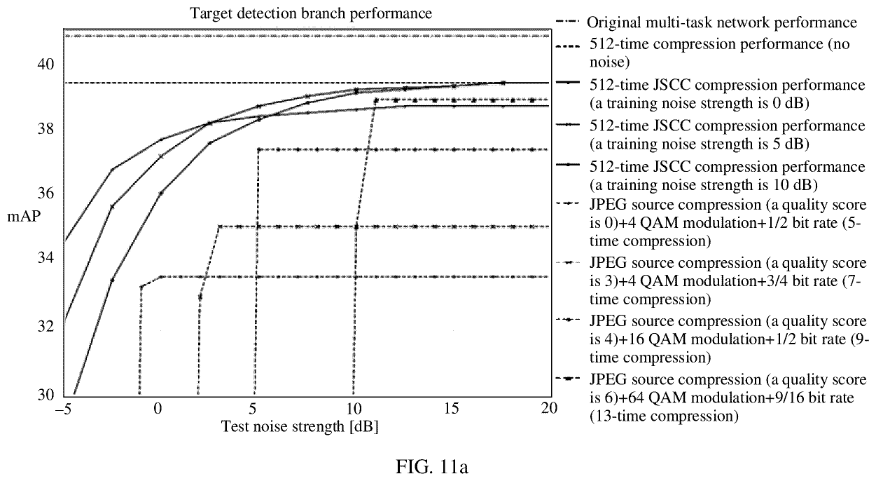

FIG. 11a and FIG. 11b are performance comparison diagrams of a conventional separation method and a joint source-channel coding JSCC model according to an embodiment of this application. In FIG. 11a and FIG. 11b, a quality score is a parameter that controls a compression capability of a JPEG algorithm, and a smaller quality score indicates a larger compression capability. A bit rate indicates a ratio of a quantity of source coded bits (bits) to a quantity of bits after channel coding. QAM indicates that every xx bits in a bit stream after source coding and channel coding are modulated into one symbol number, and finally a signal input to a channel is obtained. A compression rate of the separation method is a ratio of a quantity of symbols of the fusion feature before compression, that is, a feature dimension to a quantity of symbols after compression, channel coding, and modulation.

According to the joint source-channel coding model provided in this embodiment of this application, 512-time or 1024-time compression can be achieved while a recognition rate is ensured, and anti-noise capability is also provided. In the future, deployment on the device side and the cloud side can reduce storage, computing, and transmission overheads on the device side, resist channel noise, and ensure transmission robustness.

It should be noted that examples in the application scenarios in this application merely show some possible implementations, to help better understand and describe the method in this application. A person skilled in the art may obtain examples of some evolved forms according to the multi-task network model-based communication method provided in this application.

The foregoing describes the methods provided in embodiments of this application. To implement functions in the methods provided in the foregoing embodiments of this application, the communication apparatus may include a hardware structure and/or a software module, to implement the foregoing functions by using the hardware structure, the software module, or a combination of the hardware structure and the software module. Whether a function in the foregoing functions is performed by using the hardware structure, the software module, or the combination of the hardware structure and the software module depends on particular applications and implementation constraints of the technical solutions.

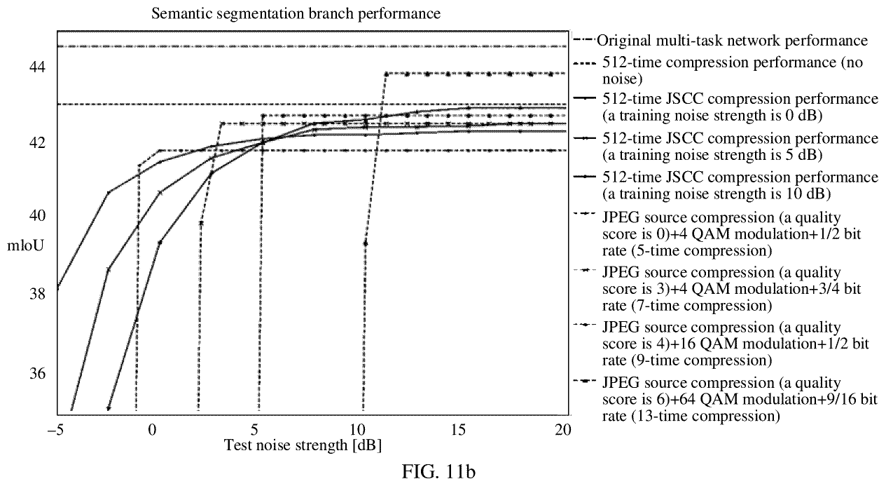

As shown in FIG. 12, based on a same technical concept, an embodiment of this application further provides a communication apparatus 1200. The communication apparatus 1200 may be a communication apparatus, or an apparatus in the communication apparatus, or an apparatus that can be used in a match with the communication apparatus. The communication apparatus 1200 may be a terminal device or a network device. In an implementation, the communication apparatus 1200 may include a one-to-one corresponding module for performing methods/operations/steps/actions performed by the first communication apparatus or the second communication apparatus in the foregoing method embodiment. The module may be a hardware circuit, or may be software, or may be implemented by the hardware circuit in combination with the software. In an implementation, the apparatus may include a processing module 1201 and a transceiver module 1202. The processing module 1201 is configured to invoke the transceiver module 1202 to perform a receiving function and/or a sending function.

When the communication apparatus 1200 is configured to perform the method of the first communication apparatus,
the processing module 1201 is configured to process an input signal by using a first backbone network model in a multi-task network model, to obtain a fusion feature, where the fusion feature is obtained by fusing a plurality of first features, and the plurality of first features are obtained by performing feature extraction on the input signal; and is configured to perform compression and channel coding on the fusion feature to obtain first information; and
the transceiver module 1202 is configured to send the first information to a second communication apparatus.

The transceiver module 1202 is further configured to perform a signal receiving or sending related operation performed by the first communication apparatus in the foregoing method embodiment. The processing module 1201 is further configured to perform an operation other than signal receiving and sending performed by the first communication apparatus in the foregoing method embodiment. The first communication apparatus may be a terminal device or may be a network device.

When the communication apparatus 1200 is configured to perform the method of the second communication apparatus,
the transceiver module 1202 is configured to receive second information from a first communication apparatus; and
the processing module 1201 is configured to: perform decompression and channel decoding on the second information, to obtain a reconstructed feature of a fusion feature, where the fusion feature is obtained by fusing a plurality of first features obtained by performing feature extraction on an input signal; perform feature parsing on the reconstructed feature by using a second backbone network model in a multi-task network model, to obtain a feature parsing result; and process the feature parsing result by using a functional network model in the multi-task network model.

The transceiver module 1202 is further configured to perform a signal receiving or sending related operation performed by the second communication apparatus in the foregoing method embodiment. The processing module 1201 is further configured to perform an operation other than signal receiving and sending performed by the second communication apparatus in the foregoing method embodiment. The second communication apparatus may be a terminal device or may be a network device.

Division into the modules in embodiments of this application is an example, is merely division into logical functions, and may be other division during actual implementation. In addition, functional modules in embodiments of this application may be integrated into one processor, or each of the modules may exist alone physically, or two or more modules may be integrated into one module. The integrated module may be implemented in a form of hardware, or may be implemented in a form of a software functional module.

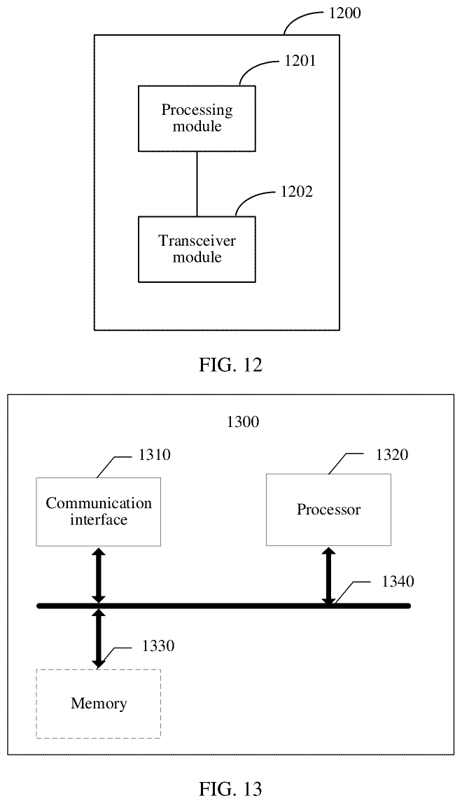

FIG. 13 shows a communication apparatus 1300 according to an embodiment of this application. The communication apparatus 1300 is configured to implement a function of the communication apparatus in the foregoing method. The communication apparatus may be the first communication apparatus or may be the second communication apparatus. When a function of the first communication apparatus is implemented, the apparatus may be the first communication apparatus, an apparatus in the first communication apparatus, or an apparatus that can be used in a match with the first communication apparatus. When a function of the second communication apparatus is implemented, the apparatus may be the second communication apparatus, an apparatus in the second communication apparatus, or an apparatus that can be used in a match with the second communication apparatus. The communication apparatus 1300 may be a chip system. In embodiments of this application, the chip system may include a chip, or may include a chip and another discrete component. The communication apparatus 1300 includes at least one processor 1320, configured to implement a function of the first communication apparatus or the second communication apparatus in the method provided in embodiments of this application. The communication apparatus 1300 may further include a communication interface 1310. In embodiments of this application, the communication interface may be a transceiver, a circuit, a bus, a module, or a communication interface of another type, and is configured to communicate with another apparatus by using a transmission medium. For example, the communication interface 1310 is used by the apparatus in the communication apparatus 1300 to communicate with the another apparatus. For example, when the communication apparatus 1300 is the first communication apparatus, the another apparatus may be the second communication apparatus. For another example, when the communication apparatus 1300 is the second communication apparatus, the another apparatus may be the first communication apparatus. For another example, when the communication apparatus 1300 is a chip, the another apparatus may be another chip or component in a communication device. The processor 1320 receives and sends data through the communication interface 1310, and is configured to implement the methods in the foregoing method embodiments.

For example, when the communication apparatus 1300 is configured to perform the method of the first communication apparatus,
the processor 1320 is configured to process an input signal by using a first backbone network model, to obtain a fusion feature, where the fusion feature is obtained by fusing a plurality of first features, and the plurality of first features are obtained by performing feature extraction on the input signal; the processor 1320 is further configured to perform compression and channel coding on the fusion feature to obtain first information; and the communication interface 1310 is configured to send the first information to a second communication apparatus.

Optionally, when processing the input signal by using the first backbone network model to obtain the fusion feature, the processor 1320 is configured to: perform feature extraction on the input signal to obtain a plurality of second features, where the plurality of second features have different feature dimensions; process the feature dimensions of the plurality of second features to obtain the plurality of first features having a same feature dimension; and perform feature fusion on the plurality of first features to obtain the fusion feature.

Optionally, when processing the feature dimensions of the plurality of first features to obtain the plurality of first features having the same feature dimension, the processor 1320 is configured to perform a first convolution operation and an upsampling operation on the plurality of first features, to obtain the plurality of first features having the same feature dimension.

Optionally, when performing feature fusion on the plurality of first features to obtain the fusion feature, the processor 1320 is configured to add the plurality of first features to obtain a third feature.

Optionally, the processor 1320 is further configured to perform a second convolution operation on the third feature to obtain the fusion feature.

Optionally, when performing compression and channel protection processing on the fusion feature, the processor 1320 is configured to perform downsampling and a third convolution operation on the fusion feature by using a joint source-channel coding model, to obtain a fourth feature, where the joint source-channel coding model is trained based on channel noise.

Optionally, when performing compression and channel protection processing on the fusion feature, the processor 1320 is further configured to perform one or more of the following operations on the fourth feature by using the joint source-channel coding model: generalized divisive normalization, a parametric rectified linear unit, or power normalization.

When the communication apparatus 1300 is configured to perform the method of the second communication apparatus,
the communication interface 1310 is configured to receive second information from a first communication apparatus; and the processor 1320 is configured to: perform decompression and channel decoding on the second information, to obtain a reconstructed feature of a fusion feature, where the fusion feature is obtained by fusing a plurality of first features obtained by performing feature extraction on an input signal; perform feature parsing on the reconstructed feature by using a second backbone network model in a multi-task network model, to obtain a feature parsing result; and process the feature parsing result by using a functional network model in the multi-task network model.

In a possible implementation, the feature parsing result includes X features, a 1^{st} feature in the X features is the reconstructed feature, and an (Xᵢ₊₁)^{th} feature in the X features is obtained through an operation on an Xᵢ^{th} feature; first Y features in the X features are obtained through a first operation, and last (X-Y) features in the X features are obtained through a second operation; and X, Y, and i are positive integers, i is less than or equal to X, and Y is less than or equal to X; and a convolution operation in the first operation has a plurality of receptive fields, and a convolution operation in the second operation has one receptive field.

In a possible implementation, a height of the Xᵢ₊₁^{th} feature is ½ of a height of the Xᵢ^{th} feature, a width of the Xᵢ₊₁^{th} feature is ½ of a width of the Xᵢ^{th} feature, and a channel number the Xᵢ₊₁^{th} feature is the same as a channel number the Xᵢ^{th} feature.

In a possible implementation, when performing decompression and channel decoding on the second information, the processor 1320 is configured to perform the following operations on the second information by using a joint source-channel decoding model: a fourth convolution operation, an upsampling operation, and a fifth convolution operation.

In a possible implementation, when performing decompression and channel decoding on the second information, the processor 1320 is further configured to perform one or more of the following operations: inverse generalized divisive normalization, a parametric rectified linear unit, batch normalization, or a rectified linear unit.

The processor 1320 and the communication interface 1310 may be further configured to perform other corresponding steps or operations performed by the first communication apparatus or the second communication apparatus in the foregoing method embodiment.

The communication apparatus 1300 may further include at least one memory 1330, configured to store program instructions and/or data. The memory 1330 is coupled to the processor 1320. The coupling in embodiments of this application may be an indirect coupling or a communication connection between apparatuses, units, or modules in an electrical form, a mechanical form, or another form, and is used for information exchange between the apparatuses, the units, or the modules. The processor 1320 may operate in collaboration with the memory 1330. The processor 1320 may execute the program instructions stored in the memory 1330. At least one of the at least one memory may be integrated with the processor.

In embodiments of this application, a specific connection medium between the communication interface 1310, the processor 1320, and the memory 1330 is not limited. In embodiments of this application, in FIG. 13, the memory 1330, the processor 1320, and the communication interface 1310 are connected through a bus 1340. The bus is represented by a bold line in FIG. 13. A connection manner between other components is merely an example for description, and is not limited thereto. The bus may be classified into an address bus, a data bus, a control bus, and the like. For ease of indication, the bus is indicated by using only one thick line in FIG. 13. However, this does not indicate that there is only one bus or only one type of bus.

In embodiments of this application, the processor 1320 may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module.

In embodiments of this application, the memory 1330 may be a non-volatile memory, for example, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store the program instructions and/or the data.

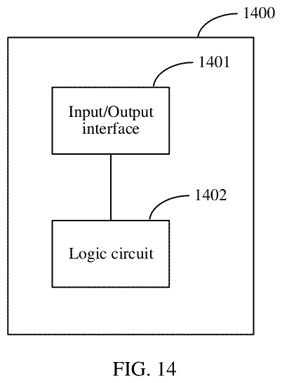

Based on a same technical concept as the method embodiment, as shown in FIG. 14, an embodiment of this application further provides a communication apparatus 1400. The communication apparatus 1400 is configured to perform operations performed by the first communication apparatus or the second communication apparatus in the foregoing multi-task network model-based communication method. The communication apparatus 1400 may be a chip system. In embodiments of this application, the chip system may include a chip, or may include a chip and another discrete component. Some or all of multi-task network model-based communication methods in the foregoing embodiments may be implemented by hardware or may be implemented by software. When the communication method is implemented by hardware, the communication apparatus 1400 includes an input/output interface 1401 and a logic circuit 1402. In embodiments of this application, the input/output interface 1401 may be a transceiver, a circuit, a bus, a module, or a communication interface of any type, and is configured to communicate with another apparatus by using a transmission medium. For example, the input/output interface 1401 is used by the apparatus in the communication apparatus 1400 to communicate with the another apparatus. For example, when the communication apparatus 1400 is the first communication apparatus, the another apparatus may be the second communication apparatus. For another example, when the communication apparatus 1400 is the second communication apparatus, the another apparatus may be the first communication apparatus. For another example, when the communication apparatus 1400 is a chip, the another apparatus may be another chip or component in a communication device.

For example, when the communication apparatus 1400 is configured to perform the method of the first communication apparatus,
the logic circuit 1402 is configured to process an input signal by using a first backbone network model, to obtain a fusion feature, where the fusion feature is obtained by fusing a plurality of first features, and the plurality of first features are obtained by performing feature extraction on the input signal; the processing module is further configured to perform compression and channel coding on the fusion feature to obtain first information; and the input/output interface 1401 is configured to send the first information to a second communication apparatus.

Optionally, when processing the input signal by using the first backbone network model to obtain the fusion feature, the logic circuit 1402 is configured to: perform feature extraction on the input signal to obtain a plurality of second features, where the plurality of second features have different feature dimensions; process the feature dimensions of the plurality of second features to obtain the plurality of first features having a same feature dimension; and perform feature fusion on the plurality of first features to obtain the fusion feature.

Optionally, when processing the feature dimensions of the plurality of first features to obtain the plurality of first features having the same feature dimension, the logic circuit 1402 is configured to perform a first convolution operation and an upsampling operation on the plurality of first features, to obtain the plurality of first features having the same feature dimension.

Optionally, when performing feature fusion on the plurality of first features to obtain the fusion feature, the logic circuit 1402 is configured to add the plurality of first features to obtain a third feature.

Optionally, the logic circuit 1402 is further configured to perform a second convolution operation on the third feature to obtain the fusion feature.

Optionally, when performing compression and channel protection processing on the fusion feature, the logic circuit 1402 is configured to perform downsampling and a third convolution operation on the fusion feature by using a joint source-channel coding model, to obtain a fourth feature, where the joint source-channel coding model is trained based on channel noise.

Optionally, when performing compression and channel protection processing on the fusion feature, the logic circuit 1402 is further configured to perform one or more of the following operations on the fourth feature by using the joint source-channel coding model: generalized divisive normalization, a parametric rectified linear unit, or power normalization.

When the communication apparatus 1400 is configured to perform the method of the second communication apparatus,
the input/output interface 1401 is configured to receive second information from a first communication apparatus; and the logic circuit 1402 is configured to: perform decompression and channel decoding on the second information, to obtain a reconstructed feature of a fusion feature, where the fusion feature is obtained by fusing a plurality of first features obtained by performing feature extraction on an input signal; perform feature parsing on the reconstructed feature by using a second backbone network model in a multi-task network model, to obtain a feature parsing result; and process the feature parsing result by using a functional network model in the multi-task network model.

In a possible implementation, the feature parsing result includes X features, a 1^{st} feature in the X features is the reconstructed feature, and an (Xᵢ₊₁)^{th} feature in the X features is obtained through an operation on an Xᵢ^{th} feature; first Y features in the X features are obtained through a first operation, and last (X-Y) features in the X features are obtained through a second operation; and X, Y, and i are positive integers, i is less than or equal to X, and Y is less than or equal to X; and a convolution operation in the first operation has a plurality of receptive fields, and a convolution operation in the second operation has one receptive field.

In a possible implementation, a height of the Xᵢ₊₁^{th} feature is ½ of a height of the Xᵢ^{th} feature, a width of the Xᵢ₊₁^{th} feature is ½ of a width of the Xᵢ^{th} feature, and a channel number the Xᵢ₊₁^{th} feature is the same as a channel number the Xᵢ^{th} feature.

In a possible implementation, when performing decompression and channel decoding on the second information, the logic circuit 1402 is configured to perform the following operations on the second information by using a joint source-channel decoding model: a fourth convolution operation, an upsampling operation, and a fifth convolution operation.

In a possible implementation, when performing decompression and channel decoding on the second information, the logic circuit 1402 is further configured to perform one or more of the following operations: inverse generalized divisive normalization, a parametric rectified linear unit, batch normalization, or a rectified linear unit.

The logic circuit 1402 and the input/output interface 1401 may be further configured to perform other corresponding steps or operations performed by the first communication apparatus or the second communication apparatus in the foregoing method embodiment.

When the communication apparatus 1200, the communication apparatus 1300, and the communication apparatus 1400 are specifically chips or chip systems, baseband signals may be output or received by the transceiver module 1202, the communication interface 1310, and the input/output interface 1401. When the communication apparatus 1200, the communication apparatus 1300, and the communication apparatus 1400 are specifically devices, radio frequency signals may be output or received by the transceiver module 1202, the communication interface 1310, and the input/output interface 1401.

Some or all of the operations and functions performed by the first communication apparatus/second communication apparatus described in the foregoing method embodiments of this application may be implemented by using a chip or an integrated circuit.

An embodiment of this application provides a computer-readable storage medium storing a computer program. The computer program includes instructions used to perform the foregoing method embodiments.

An embodiment of this application provides a computer program product including instructions. When the computer program product runs on a computer, the foregoing method embodiments are performed.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

Although some embodiments of this application have been described, a person skilled in the art can make changes and modifications to these embodiments once they learn the basic technical concept. Therefore, the following claims are intended to be construed as to cover the preferred embodiments and all changes and modifications falling within the scope of this application.

A person skilled in the art can make various modifications and variations to embodiments of this application without departing from the spirit and scope of embodiments of this application. This application is intended to cover these modifications and variations provided that they fall within the scope of protection defined by the following claims and their equivalent technologies.

What is claimed is:

1. A multi-task network model-based communication method, a multi-task network model including a first backbone network model, and the method comprising:
obtaining a fusion feature by processing, by a first communication apparatus, an input signal by using the first backbone network model, wherein
the fusion feature is obtained by fusing a plurality of first features, and
the plurality of first features are obtained by performing feature extraction on the input signal;
obtaining first information by performing, by the first communication apparatus, compression and channel coding on the fusion feature; and
sending, by the first communication apparatus, the first information to a second communication apparatus.

2. The method according to claim 1, wherein obtaining the fusion feature comprises:
obtaining a plurality of second features by performing, by the first communication apparatus, feature extraction on the input signal, wherein the plurality of second features have different feature dimensions;
obtaining the plurality of first features having a same feature dimension by processing, by the first communication apparatus, the feature dimensions of the plurality of second features; and
obtaining the fusion feature by performing, by the first communication apparatus, feature fusion on the plurality of first features.

3. The method according to claim 2, wherein obtaining the plurality of first features having the same feature dimension comprises:
performing, by the first communication apparatus, a first convolution operation and an upsampling operation on the plurality of first features.

4. The method according to claim 2, wherein obtaining the fusion feature comprises:
obtaining a third feature by adding, by the first communication apparatus, the plurality of first features.

5. The method according to claim 4, further comprising:
obtaining the fusion feature by performing, by the first communication apparatus, a second convolution operation on the third feature.

6. The method according to claim 1, wherein performing, by the first communication apparatus, the compression and channel coding on the fusion feature comprises:
obtaining a fourth feature by performing, by the first communication apparatus, downsampling and a third convolution operation on the fusion feature by using a joint source-channel coding model, wherein the joint source-channel coding model is trained based on channel noise.

7. The method according to claim 6, wherein performing, by the first communication apparatus, the compression and channel coding on the fusion feature further comprises:
performing, by the first communication apparatus, one or more of the following operations on the fourth feature by using the joint source-channel coding model: generalized divisive normalization, a parametric rectified linear unit (PreLU), or power normalization.

8. A multi-task network model-based communication method, a multi-task network model including a second backbone network model and a functional network model, and the method comprising:
receiving, by a second communication apparatus, second information from a first communication apparatus;
obtaining a reconstructed feature of a fusion feature by performing, by the second communication apparatus, decompression and channel decoding on the second information, wherein the fusion feature is obtained by fusing a plurality of first features obtained by performing feature extraction on an input signal;
obtaining a feature parsing result by performing, by the second communication apparatus, feature parsing on the reconstructed feature by using the second backbone network model; and
processing, by the second communication apparatus, the feature parsing result by using the functional network model.

9. The method according to claim 8, wherein
the feature parsing result includes X features,
a 1^{st} feature in the X features is the reconstructed feature,
an (Xᵢ₊₁)^{th} feature in the X features is obtained through an operation on an Xᵢ^{th} feature,
first Y features in the X features are obtained through a first operation,
last (X-Y) features in the X features are obtained through a second operation,
X, Y, and i are positive integers,
i is less than or equal to X,
Y is less than or equal to X,
a convolution operation in the first operation has a plurality of receptive fields, and
a convolution operation in the second operation has one receptive field.

10. The method according to claim 9, wherein
a height of the Xᵢ₊₁^{th} feature is ½ of a height of the Xᵢ^{th} feature,
a width of the Xᵢ₊₁^{th} feature is ½ of a width of the Xᵢ^{th} feature, and
a channel number of the Xᵢ₊₁^{th} feature is the same as a channel number of the Xᵢ^{th} feature.

11. The method according to claim 8, wherein performing, by the second communication apparatus, the decompression and channel decoding on the second information comprises:
performing, by the second communication apparatus, the following operations on the second information by using a joint source-channel decoding model: a fourth convolution operation, an upsampling operation, and a fifth convolution operation.

12. The method according to claim 11, wherein performing, by the second communication apparatus, the decompression and channel decoding on the second information further comprises one or more of the following operations: inverse generalized divisive normalization, a parametric rectified linear unit (PreLU), batch normalization, or a rectified linear unit (ReLU).

13. A communication apparatus, comprising:
a processor; and
a communication interface, wherein
the processor and communication interface are configured to operate in cooperation to cause the communication apparatus to:
obtain a fusion feature by processing an input signal by using a first backbone network model, wherein
the fusion feature is obtained by fusing a plurality of first features, and
the plurality of first features are obtained by performing feature extraction on the input signal;
perform compression and channel coding on the fusion feature to obtain first information; and
send the first information to a second communication apparatus.

14. The communication apparatus according to claim 13, wherein the communication apparatus is further caused to:
obtain a plurality of second features by performing feature extraction on the input signal, wherein the plurality of second features have different feature dimensions;
obtain the plurality of first features having a same feature dimension by processing the feature dimensions of the plurality of second features; and
obtain the fusion feature by performing, feature fusion on the plurality of first features.

15. The communication apparatus according to claim 14, wherein the communication apparatus is further caused to:
obtain the plurality of first features having the same feature dimension by performing a first convolution operation and an upsampling operation on the plurality of first features.

16. The communication apparatus according to claim 14, wherein the communication apparatus is further caused to:
obtain a third feature by adding the plurality of first features.

17. The communication apparatus according to claim 16, the communication apparatus is further caused to:
obtain the fusion feature by performing a second convolution operation on the third feature.

18. The communication apparatus according to claim 13, the communication apparatus is further caused to:
obtain a fourth feature by performing downsampling and a third convolution operation on the fusion feature by using a joint source-channel coding model, wherein the joint source-channel coding model is trained based on channel noise.

19. The communication apparatus according to claim 18, the communication apparatus is further caused to:
perform one or more of the following operations on the fourth feature by using the joint source-channel coding model: generalized divisive normalization, a parametric rectified linear unit (PreLU), or power normalization.
